(19) United States
(12) Patent Application Publication
(10) Pub. No.: US 2025/0097877 A1
(43) Pub. Date: Mar. 20, 2025

(54) METHODS AND APPARATUS BURST SOUNDING REFERENCE SIGNALS FOR POSITIONING

(71) Applicant: QUALCOMM Incorporated, San Diego, CA (US)

(72) Inventors: Marwen ZORGUI, San Diego, CA (US); Srinivas YERRAMALLI, San Diego, CA (US); Alexandros MANOLAKOS, Athens (GR); Mukesh KUMAR, Hyderabad (IN)

(21) Appl. No.: 18/294,150

(22) PCT Filed: Jun. 27, 2022
(86) PCT No.: PCT/US2022/035106

§ 371 Date: Jan. 31, 2024

(30) Foreign Application Priority Data
Sep. 9, 2021 (GR) 20210100595

(51) Int. Cl. H04W 64/00; H04L 5/00; H04W 76/20; H04W 80/02

(52) U.S. Cl. CPC H04W 64/00; H04L 5/0051; H04W 76/20; H04W 80/02

(57) ABSTRACT

A user equipment (UE) is configured for supporting positioning using sounding reference signal (SRS) periodic burst transmissions that includes a plurality of sets of SRS transmissions, where each set of SRS transmissions includes a repetition of SRS resources. The configuration for the SRS periodic burst transmissions includes a start time for the SRS periodic burst transmissions, a repetition configuration for the SRS resources within each set, and a repetition configuration for the plurality of sets of SRS transmissions. The configuration may be received in a Radio Resource Control (RRC) configuration message or a Medium Access Control-Control Element (MAC-CE) message that activates the SRS periodic burst transmissions, and the SRS periodic burst transmissions may be deactivated with a RRC reconfiguration message or another MAC-CE message.

### CROSS-REFERENCE TO RELATED APPLICATION

This application claims the benefit of Greek patent application No. 20210100595, entitled “METHODS AND APPARATUS BURST SOUNDING REFERENCE SIGNALS FOR POSITIONING,” filed Sep. 9, 2021, which is assigned to the assignee hereof and which is expressly incorporated herein by reference in its entirety.

### BACKGROUND

### Field

Subject matter disclosed herein relates to location determination for a mobile device and more particularly to supporting a location session for a mobile device using on uplink signaling.

### Relevant Background

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., LTE or WiMax). A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor.

Obtaining the location of a mobile device that is accessing a wireless (e.g. 5G) network may be useful for many applications including, for example, emergency calls, personal navigation, asset tracking, locating a friend or family member, etc. Locating a mobile device is also becoming increasingly important in fully autonomous scenarios such as a warehouse, automated factory and for drones and self-driving vehicles.

### SUMMARY

The following presents a simplified summary relating to one or more aspects disclosed herein. As such, the following summary should not be considered an extensive overview relating to all contemplated aspects, nor should the following summary be regarded to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

A user equipment (UE) is configured for supporting positioning using sounding reference signal (SRS) periodic burst transmissions that includes a plurality of sets of SRS transmissions, where each set of SRS transmissions includes a repetition of SRS resources. The configuration for the SRS periodic burst transmissions includes a start time for the SRS periodic burst transmissions, a repetition configuration for the SRS resources within each set, and a repetition configuration for the plurality of sets of SRS transmissions. The configuration may be received in a Radio Resource Control (RRC) configuration message or a Medium Access Control-Control Element (MAC-CE) message that activates the SRS periodic burst transmissions, and the SRS periodic burst transmissions may be deactivated with a RRC reconfiguration message or another MAC-CE message.

In one implementation, a method performed by a user equipment (UE) for positioning of the UE, includes receiving a configuration for sounding reference signal (SRS) periodic burst transmissions may include a plurality of sets of SRS transmissions, each set of SRS transmissions may include a repetition of SRS resources, wherein the configuration for the SRS periodic burst transmissions may include a start time for the SRS periodic burst transmissions, a repetition configuration for the SRS resources, and a repetition configuration for the plurality of sets of SRS transmissions; and transmitting the SRS periodic burst transmissions to one or more base stations for positioning.

In one implementation, a user equipment (UE) configured for positioning of the UE, includes a wireless transceiver configured to wirelessly communicate with base stations in a wireless network; at least one memory; and at least one processor coupled to the wireless transceiver and the at least one memory and configured to: receive, via the wireless transceiver, a configuration for sounding reference signal (SRS) periodic burst transmissions may include a plurality of sets of SRS transmissions, each set of SRS transmissions may include a repetition of SRS resources, wherein the configuration for the SRS periodic burst transmissions may include a start time for the SRS periodic burst transmissions, a repetition configuration for the SRS resources, and a repetition configuration for the plurality of sets of SRS transmissions; and transmit, via the wireless transceiver, the SRS periodic burst transmissions to one or more base stations for positioning.

In one implementation, a user equipment (UE) configured for positioning of the UE, includes means for receiving a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and means for transmitting the SRS periodic burst transmissions to one or more base stations for positioning.

In one implementation, a non-transitory computer-readable storage medium including program code stored thereon, the program code is operable to configure at least one processor in a user equipment (UE) for positioning of the UE, the program code comprising instructions to: receive a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and transmit the SRS periodic burst transmissions to one or more base stations for positioning.

In one implementation, a method performed by a network entity for positioning of a user equipment (UE), includes sending to the UE a configuration for sounding reference signal (SRS) periodic burst transmissions may include a plurality of sets of SRS transmissions, each set of SRS transmissions may include a repetition of SRS resources, wherein the configuration for the SRS periodic burst transmissions may include a start time for the SRS periodic burst transmissions, a repetition configuration for the SRS resources, and a repetition configuration for the plurality of sets of SRS transmissions; and obtaining positioning measurements for each set of SRS transmissions transmitted by the UE, wherein a plurality of position estimates for the UE are determined, wherein each position estimate is based on the positioning measurements for an associated set of SRS transmissions.

In one implementation, a network entity configured for positioning of a user equipment (UE), includes an external interface configured to wirelessly communicate with entities in a wireless network; at least one memory; and at least one processor coupled to the external interface and the at least one memory and configured to: send, via the external interface, to the UE a configuration for sounding reference signal (SRS) periodic burst transmissions may include a plurality of sets of SRS transmissions, each set of SRS transmissions may include a repetition of SRS resources, wherein the configuration for the SRS periodic burst transmissions may include a start time for the SRS periodic burst transmissions, a repetition configuration for the SRS resources, and a repetition configuration for the plurality of sets of SRS transmissions; and obtain, via the external interface, positioning measurements for each set of SRS transmissions transmitted by the UE, wherein a plurality of position estimates for the UE are determined, wherein each position estimate is based on the positioning measurements for an associated set of SRS transmissions.

In one implementation, a network entity configured for positioning of a user equipment (UE), includes means for sending to the UE a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and means for obtaining positioning measurements for each set of SRS transmissions transmitted by the UE, wherein a plurality of position estimates for the UE are determined, wherein each position estimate is based on the positioning measurements for an associated set of SRS transmissions.

In one implementation, a non-transitory computer-readable storage medium including program code stored thereon, the program code is operable to configure at least one processor in a network entity for positioning of a user equipment (UE), the program code comprising instructions to: send to the UE a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and obtain positioning measurements for each set of SRS transmissions transmitted by the UE, wherein a plurality of position estimates for the UE are determined, wherein each position estimate is based on the positioning measurements for an associated set of SRS transmissions.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates a wireless communication system including a Next Generation (NG) Radio Access Network (RAN).

FIG. 2 shows an architecture diagram of an NG-RAN node that may be within an NG-RAN.

FIG. 3 shows a structure of an exemplary subframe sequence with positioning reference signal (PRS) positioning occasions.

FIG. 4 schematically illustrates a configuration for periodic burst of SRS resources, shown as repeating sets of repeating SRS resources.

FIG. 5 is a message flow illustrating messaging between a location server, base station, and the UE for UE positioning using periodic burst SRS resources.

FIG. 6 shows a schematic block diagram illustrating certain exemplary features of a UE that is configured to support UE positioning using periodic burst SRS resources.

FIG. 7 shows a schematic block diagram illustrating certain exemplary features of a network entity that is configured to support UE positioning using periodic burst SRS resources.

FIG. 8 shows a flowchart for an exemplary method for supporting positioning of a UE using periodic burst SRS resources.

FIG. 9 shows a flowchart for an exemplary method for supporting positioning of a UE using periodic burst SRS resources

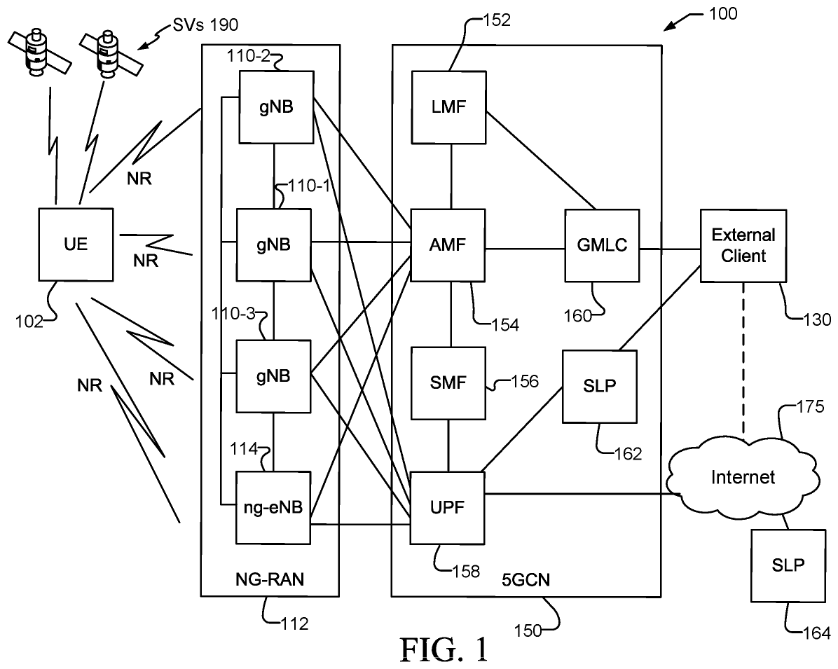

Elements, stages, steps, and/or actions with the same reference label in different drawings may correspond to one another (e.g., may be similar or identical to one another). Further, some elements in the various drawings are labelled using a numeric prefix followed by an alphabetic or numeric suffix. Elements with the same numeric prefix but different suffixes may be different instances of the same type of element. The numeric prefix without any suffix is used herein to reference any element with this numeric prefix. For example, different instances 110-1 and 110-2 of a gNB are shown in FIG. 1. A reference to a gNB 110 may then refer to either of gNBs 110-1 and 110-2.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular Radio Access Technology (RAT), unless otherwise noted. In general, a UE may be any wireless communication device (e.g., a mobile phone, router, tablet computer, laptop computer, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) enabled to communicate over a wireless communications network on behalf of a user, a service, or some autonomous function. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB), etc. In addition, in some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission point or to multiple physical transmission points that may or may not be co-located. For example, where the term “base station” refers to a single physical transmission point, the physical transmission point may be an antenna of the base station corresponding to a cell of the base station. Where the term “base station” refers to multiple co-located physical transmission points, the physical transmission points may be an array of antennas (e.g., as in a multiple-input multiple-output (MIMO) system or where the base station employs beamforming) of the base station. Where the term “base station” refers to multiple non-co-located physical transmission points, the physical transmission points may be a distributed antenna system (DAS) (a network of spatially separated antennas connected to a common source via a transport medium) or a remote radio head (RRH) (a remote base station connected to a serving base station). Alternatively, the non-co-located physical transmission points may be the serving base station receiving the measurement report from the UE and a neighbor base station whose reference RF signals the UE is measuring.

To support positioning of a UE, two broad classes of location solution have been defined: control plane and user plane. With control plane (CP) location, signaling related to positioning and support of positioning may be carried over existing network (and UE) interfaces and using (mainly) existing protocols dedicated to the transfer of signaling. With user plane (UP) location, signaling related to positioning and support of positioning may be carried as part of other data using such protocols as the Internet Protocol (IP), Transmission Control Protocol (TCP) and User Datagram Protocol (UDP).

The Third Generation Partnership Project (3GPP) has defined control plane location solutions for UEs that use radio access according to Global System for Mobile communications GSM (2G), Universal Mobile Telecommunications System (UMTS) (3G), LTE (4G) and New Radio (NR) for Fifth Generation (5G). These solutions are defined in 3GPP Technical Specifications (TSs) 23.271 and 23.273 (common parts), 43.059 (GSM access), 25.305 (UMTS access), 36.305 (LTE access) and 38.305 (NR access). The Open Mobile Alliance (OMA) has similarly defined a UP location solution known as Secure User Plane Location (SUPL) which can be used to locate a UE accessing any of a number of radio interfaces that support IP packet access such as General Packet Radio Service (GPRS) with GSM, GPRS with UMTS, or IP access with LTE, NR, or WiFi.

Both CP and UP location solutions may employ a location server to support positioning. The location server may be part of or accessible from a serving network or a home network for a UE or may simply be accessible over the Internet or over a local Intranet. If positioning of a UE is needed, a location server may instigate a session (e.g. a location session or a SUPL session) with the UE and coordinate downlink (DL) location measurements by the UE, e.g., of positioning reference signals (PRS) transmitted by base stations, and determination of an estimated location of the UE based on the DL location measurements. The location server may additionally or alternatively coordinate uplink (UL) location measurements by one or more base stations, e.g., of reference signals (such as sounding reference signals (SRS) transmitted by the UE, and determination of an estimated location of the UE based on the UL location measurements or both DL location measurements by the UE and UL location measurements by the base station(s). During a location session, a location server may request positioning capabilities of the UE (or the UE may provide them without a request), may provide assistance data to the UE (e.g. if requested by the UE or in the absence of a request) to assist the UE in obtaining DL location measurements, transmitting SRS for positioning, and/or in calculating a location estimate, and may request a location estimate or location measurements from a UE and/or base stations.

To obtain a location estimate, a location server (and a UE) may employ positioning using a Global Navigation Satellite System (GNSS), Assisted GNSS (A-GNSS), Time Difference of Arrival (TDOA), Angle of Departure (AOD), Angle of Arrival (AOA), Round Trip Time (RTT), multi-cell RTT (also referred to as multi-RTT), or a combination thereof or other position methods. Assistance data may be used by a UE to help acquire and measure GNSS signals and/or positioning reference signal (PRS) signals (e.g. by providing expected characteristics of these signals such as frequency, expected time of arrival, signal coding, signal Doppler).

In a UE based mode of operation, assistance data may also or instead be used by a UE to help determine a location estimate from the resulting location measurements (e.g., if the assistance data provides satellite ephemeris data in the case of GNSS positioning or base station locations and other base station characteristics such as PRS timing in the case of terrestrial positioning using, e.g., TDOA, AOD, Multi-RTT, etc.).

In a UE assisted mode of operation, a UE may return location measurements to a location server which may determine an estimated location of the UE based on these measurements and possibly based also on other known or configured data (e.g. satellite ephemeris data for GNSS location or base station characteristics including base station locations and possibly PRS timing in the case of terrestrial positioning using, e.g., TDOA, AOD, Multi-RTT, etc.).

During a positioning session using UL location measurements, it is sometimes desirable for the UE to transmit SRS for positioning within a specific time window. Moreover, it is sometimes desirable for the time window for the SRS transmissions to repeat, i.e., have its own repetition interval. Currently, per Release 16 3GPP Technical Specification (TS) 38.331, SRS for positioning resources may be configured to be either periodic, semi-persistent, or aperiodic, each of which requires specific signaling to activate and deactivate transmissions of the SRS resources. The use of periodic, semi-persistent, or aperiodic SRS transmission within specific time windows, thus, requires the specific signaling to activate and deactivate transmissions of the SRS resources within a time window. If the time windows are repeating, this signaling would be required to activate and deactivate transmissions of the SRS resources within each time window, which is inefficient and increases signaling overhead.

Additionally, if the UE is to transmit SRS for positioning while in a Radio Resource Control (RRC) inactive mode, the SRS transmissions by the UE may be configured prior to entering the inactive mode, e.g., from an RRC release message, but during the inactive mode, the UE may only receive paging messages. Accordingly, activation and deactivation of SRS transmissions in repeating time windows via signaling while in RRC inactive mode may be impractical.

Accordingly, as described herein, a UE may be configured to support positioning using sounding reference signal (SRS) periodic burst transmissions. The SRS periodic burst transmissions include a plurality of sets of SRS transmissions, where each set of SRS transmissions includes a repetition of SRS resources. The configuration for the SRS periodic burst transmissions, for example, may include a start time for the SRS periodic burst transmissions, a repetition configuration for the SRS resources within each set, and a repetition configuration for the plurality of sets of SRS transmissions. The configuration for the SRS periodic burst transmissions may be received in a Radio Resource Control (RRC) configuration message or a Medium Access Control-Control Element (MAC-CE) message, which may activate the SRS periodic burst transmissions, and the SRS periodic burst transmissions may be deactivated with a RRC reconfiguration message or another MAC-CE message.

FIG. 1 shows an architecture based on a non-roaming 5G NR network to support mobile device positioning using UL transmissions as discussed herein. FIG. 1 illustrates a communication system 100 that comprises a mobile device 102, sometimes referred to herein as “UE 102”. FIG. 1 also shows components of a Fifth Generation (5G) network comprising a Next Generation Radio Access Network (NG-RAN) 112, which includes base stations (BSs) such as New Radio (NR) NodeBs or gNBs 110-1, 110-2, 110-3, and a ng-eNB 114 (sometimes individually (or collectively) referred to as base station(s) 110), and a 5G Core Network (5GCN) 150 that is in communication with an external client 130. A 5G network may also be referred to as a New Radio (NR) network; NG-RAN 112 may be referred to as an NR RAN or a 5G RAN; and 5GCN 150 may be referred to as a Next Generation (NG) Core network (NGC). The communication system 100 may further utilize information from space vehicles (SVs) 190 for a Global Navigation Satellite System (GNSS) like GPS, GLONASS, Galileo or Beidou or some other local or regional Satellite Positioning System (SPS) such as IRNSS, EGNOS or WAAS. Additional components of the communication system 100 are described below. The communication system 100 may include additional or alternative components.

FIG. 1 shows a serving gNB 110-1 for the UE 102 and neighbor gNBs 110-2, 110-3, and ng-eNB 114. A neighbor gNB may be any gNB which is able to receive and measure uplink (UL) signals transmitted by the UE 102 and/or is able to transmit a downlink (DL) reference signal (RS), e.g., positioning reference signals (PRS), that can be received and measured by the UE 102.

Entities in the NG-RAN 112 which transmit DL PRSs to be measured by a UE 102 for a particular location session are referred to generically as “Transmission Points” (TPs) and can include one or more of the serving gNB 110-1, and neighbor gNBs 110-2, 110-3, and ng-eNB 114. Entities in the NG-RAN 112 which receive and measure UL signals (e.g. an RS) transmitted by a UE 102 for a particular location session are referred to generically as “Reception Points” (RPs) and can include one or more of the serving gNB 110-1, and neighbor gNBs 110-2, 110-3, and ng-eNB 114. Entities in the NG-RAN 112 which transmit DL PRSs to be measured by a UE 102 and receive and measure UL signals transmitted by a UE 102 may sometimes be referred to as “Transmission Reception Points” (TRPs) and can include one or more of the serving gNB 110-1, and neighbor gNBs 110-2, 110-3, and ng-eNB 114

It should be noted that FIG. 1 provides only a generalized illustration of various components, any or all of which may be utilized as appropriate, and each of which may be duplicated or omitted, as necessary. Specifically, although only one UE 102 is illustrated, it will be understood that many UEs (e.g., hundreds, thousands, millions, etc.) may utilize the communication system 100. Similarly, the communication system 100 may include a larger or smaller number of SVs 190, gNBs 110-1-110-2, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), and IEEE 802.11 WiFi etc. For example, where a Wireless Local Area Network (WLAN), e.g., IEEE 802.11 radio interface, is used, the UE 102 may communicate with an Access Network (AN), as opposed to an NG-RAN, and accordingly, component 112 is sometimes referred to herein as an AN or as a RAN, denoted by the term “RAN”, “(R)AN” or “(R)AN 112”. In the case of an AN (e.g. IEEE 802.11 AN), the AN may be connected to a Non-3GPP Interworking Function (N3IWF) (e.g. in 5GCN 150) (not shown in FIG. 1), with the N3IWF connected to AMF 154.

The UE 102, as used herein, may be any electronic device and may be referred to as a device, a mobile device, a wireless device, a mobile terminal, a terminal, a mobile station (MS), a Secure User Plane Location (SUPL) Enabled Terminal (SET), or by some other name. The UE 102 may be a stand-alone device or may be embedded in another device, e.g., a factory tool, that is to be monitored or tracked. Moreover, UE 102 may correspond to a smart watch, digital glasses, fitness monitor, smart car, smart appliance, cellphone, smartphone, laptop, tablet, PDA, tracking device, control device or some other portable or moveable device. The UE 102 may include a single entity or may include multiple entities such as in a personal area network where a user may employ audio, video and/or data I/O devices and/or body sensors and a separate wireline or wireless modem. Typically, though not necessarily, the UE 102 may support wireless communication using one or more Radio Access Technologies (RATs) such as GSM, Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 112 and 5GCN 150), etc. The UE 102 may also support wireless communication using a Wireless Local Area Network (WLAN) which may connect to other networks (e.g. the Internet) using a Digital Subscriber Line (DSL) or packet cable for example. The use of one or more of these RATs may allow the UE 102 to communicate with an external client 130 (e.g. via elements of 5GCN 150 not shown in FIG. 1, or possibly via a Gateway Mobile Location Center (GMLC) 160, and/or allow the external client 130 to receive location information regarding the UE 102 (e.g., via the GMLC 160).

The UE 102 may enter a connected state with a wireless communication network that may include the NG-RAN 112. In one example, the UE 102 may communicate with a cellular communication network by transmitting wireless signals to, or receiving wireless signals from a cellular transceiver, in the NG-RAN 112, such as a gNB 110-1. A transceiver provides user and control planes protocol terminations toward the UE 102 and may be referred to as a base station, a base transceiver station, a radio base station, a radio transceiver, a radio network controller, a transceiver function, a base station subsystem (BSS), an extended service set (ESS), or by some other suitable terminology.

In particular implementations, the UE 102 and base stations 110 may have circuitry and processing resources capable of obtaining location related measurements. Location related measurements obtained by UE 102 may include measurements of signals received from satellite vehicles (SVs) 190 belonging to a Satellite Positioning System (SPS) or Global Navigation Satellite System (GNSS) such as GPS, GLONASS, Galileo or Beidou and/or may include measurements of DL signals (e.g., PRS) received from terrestrial transmitters fixed at known locations (e.g., such as gNBs), and/or measurements of sidelink signals (e.g., SRS for positioning) received from other UEs (not shown). Location related measurements obtained by base stations 110 may include measurements of uplink (UL) signals (e.g., SRS for positioning) received from UE 102. UE 102 or a location server (e.g., Location Management Function (LMF) 152) may then obtain a location estimate for the UE 102 based on these location related measurements using any one of several position methods such as, for example, GNSS, Assisted GNSS (A-GNSS), Advanced Forward Link Trilateration (AFLT), Observed Time Difference Of Arrival (OTDOA), DL-TDOA, UL-TDOA, DL-Angle of Departure (AOD), DL-Angle of Arrival (AOA), UL-AOA, UL-AOD, WLAN (also referred to as WiFi) positioning, Enhanced Cell ID (ECID), Round Trip Time (RTT), multicell RTT (multi-RTT), or combinations thereof. In some of these techniques (e.g. A-GNSS, AFLT, TDOA and DL-TDOA), pseudoranges or timing differences may be measured at UE 102 relative to a number of base stations fixed at known locations or SVs 190 with accurately known orbital data, or combinations thereof, based at least in part, on pilots, PRS, or other positioning related signals transmitted by the base stations or satellites and received at the UE 102 or based on SRS transmitted by the UE and received by a number of base stations.

The location server in FIG. 1 may correspond to, e.g., Location Management Function (LMF) 152 or Secure User Plane Location (SUPL) Location Platform (SLP) 162, may be capable of providing positioning assistance data to UE 102 including, for example, information regarding signals to be measured (e.g., expected signal timing, signal coding, signal frequencies, signal Doppler), locations and identities of terrestrial transmitters (e.g. gNBs) and/or signal, timing and orbital information for GNSS SVs to facilitate positioning techniques such as A-GNSS, AFLT, OTDOA, DL-TDOA, UL-TDOA, DL-AOD, DL-AOA, UL-AOA, UL-AOD, ECID, etc. The facilitation may include improving signal acquisition and measurement accuracy by UE 102 and, in some cases, enabling UE 102 to compute its estimated location based on the location measurements. For example, a location server (e.g. LMF 152 or SLP 162) may comprise an almanac, also referred to as a base station almanac (BSA), which indicates locations and identities of cellular transceivers and/or local transceivers in a particular region or regions such as a particular venue, and may provide information descriptive of signals transmitted by a cellular base station or AP (e.g. a gNB) such as transmission power and signal timing. A UE 102 may obtain measurements of signal strengths (e.g. received signal strength indication (RSSI)) for signals received from cellular transceivers and/or local transceivers and/or may obtain a signal to noise ratio (S/N), a reference signal received power (RSRP), a reference signal received quality (RSRQ), a time of arrival (TOA), an angle of arrival (AOA), an angle of departure (AOD), a receive time-transmission time difference (RxTx), a reference signal time difference (RSTD), or a round trip signal propagation time (RTT) between UE 102 and a cellular transceiver (e.g. a gNB) or a local transceiver (e.g. a WiFi access point (AP)). A UE 102 may use these measurements together with assistance data (e.g. terrestrial almanac data or GNSS satellite data such as GNSS Almanac and/or GNSS Ephemeris information) received from a location server (e.g. LMF 152 or SLP 162) or broadcast by a base station (e.g. a gNB 110-1-110-2) in NG-RAN 112 to determine a location for UE 102.

In some implementations, network entities are used to assist in location of a UE 102. For example, entities in a network such as gNBs 110-1-110-2 may measure UL signals transmitted by UE 102. The UL signals may include or comprise UL reference signals such as UL positioning reference signals (PRSs) or UL Sounding Reference Signals (SRSs). The entities obtaining the location measurements (e.g. gNBs 110-1-110-2) may then transfer the location measurements to the UE 102, which may use the measurements to determine RTDs for multiple transceiver pairs or transfer the location measurements to a location server. Examples of location measurements that may use UL signals can include an RSSI, RSRP, RSRQ, TOA, RxTx, AOA and RTT.

An estimate of a location of the UE 102 may be referred to as a location, location estimate, location fix, fix, position, position estimate or position fix, and may be geographic, thus providing location coordinates for the UE 102 (e.g., latitude and longitude) which may or may not include an altitude component (e.g., height above sea level, height above or depth below ground level, floor level or basement level). Alternatively, a location of the UE 102 may be expressed as a civic location (e.g., as a postal address or the designation of some point or small area in a building such as a particular room or floor). A location of the UE 102 may also be expressed as an area or volume (defined either geographically or in civic form) within which the UE 102 is expected to be located with some probability or confidence level (e.g., 67%, 95%, etc.). A location of the UE 102 may further be a relative location comprising, for example, a distance and direction or relative X, Y (and Z) coordinates defined relative to some origin at a known location which may be defined geographically, in civic terms, or by reference to a point, area, or volume indicated on a map, floor plan or building plan. The location may be expressed as an absolute location estimate for the UE, such as location coordinates or address, or as a relative location estimate for the UE, such as a distance and direction from a previous location estimate or from a known absolute location. The location of the UE may include a linear velocity, an angular velocity, a linear acceleration, an angular acceleration, an angular orientation for the UE, e.g., the orientation of the UE relative to a fixed global or local coordinate system, an identification of a trigger event for locating the UE, or some combination of these. For example, trigger events may include an area event, a motion event, or a velocity event. An area event, for example, may be the UE moving into a defined area, moving out of the area and/or remaining in the area. A motion event, for example, may include movement of the UE by a threshold straight line distance or threshold distance along a UE trajectory. A velocity event, for example, may include the UE attaining a minimum or maximum velocity, a threshold increase and/or decrease of velocity, and/or a threshold change in direction. In the description contained herein, the use of the term location may comprise any of these variants unless indicated otherwise. When computing the location of a UE, it is common to solve for local x, y, and possibly z coordinates and then, if needed, convert the local coordinates into absolute ones (e.g. for latitude, longitude and altitude above or below mean sea level).

As shown in FIG. 1, pairs of gNBs in NG-RAN 112 may be connected to one another, e.g., directly as shown in FIG. 1 or indirectly via other gNBs 110-1-110-2. Access to the 5G network is provided to UE 102 via wireless communication between the UE 102 and one or more of the gNBs 110-1-110-2, which may provide wireless communication access to the 5GCN 150 on behalf of the UE 102 using 5G (e.g. NR). In FIG. 1, the serving gNB for UE 102 is assumed to be gNB 110-1, although other gNBs (e.g. gNB 110-2, 110-3, or ng-eNB 114) may act as a serving gNB if UE 102 moves to another location or may act as a secondary gNB to provide additional throughout and bandwidth to UE 102. Some gNBs in FIG. 1 (e.g. gNB 110-2, 110-3, or ng-eNB 114) may be configured to function as positioning-only beacons which may transmit signals (e.g. directional PRS) to assist positioning of UE 102 but may not receive signals from UE 102 or from other UEs.

As noted, while FIG. 1 depicts nodes configured to communicate according to 5G communication protocols, nodes configured to communicate according to other communication protocols, such as, for example, LTE protocols, may be used. Such nodes, configured to communicate using different protocols, may be controlled, at least in part, by the 5GCN 150. Thus, the NG-RAN 112 may include any combination of gNBs, evolved Node Bs (eNBs) supporting LTE, or other types of base stations or access points. As an example, NG-RAN 112 may include one or more next generation eNBs (ng-eNBs), not shown, which provide LTE wireless access to UE 102 and may connect to entities in 5GCN 150 such as AMF 154.

The gNBs 110-1, 110-2, 110-3, and ng-eNB 114 can communicate with the Access and Mobility Management Function (AMF) 154, which, for positioning functionality, may communicate with a Location Management Function (LMF) 152. The AMF 154 may support mobility of the UE 102, including cell change and handover and may participate in supporting a signaling connection to the UE 102 and possibly helping establish and release Protocol Data Unit (PDU) sessions for UE 102 supported by the UPF 158. Other functions of AMF 154 may include: termination of a control plane (CP) interface from NG-RAN 112; termination of Non-Access Stratum (NAS) signaling connections from UEs such as UE 102, NAS ciphering and integrity protection; registration management; connection management; reachability management; mobility management; access authentication and authorization.

The gNB 110-1 may support positioning of the UE 102 when UE 102 accesses the NG-RAN 112. The gNB 110-1 may also process location service requests for the UE 102, e.g., received directly or indirectly from the GMLC 160. In some embodiments, a node/system that implements the gNB 110-1 may additionally or alternatively implement other types of location-support modules, such as an Enhanced Serving Mobile Location Center (E-SMLC) or a Secure User Plane Location (SUPL) Location Platform (SLP) 162. It will be noted that in some embodiments, at least part of the positioning functionality (including derivation of UE 102's location) may be performed at the UE 102 (e.g., using signal measurements for signals transmitted by wireless nodes, and assistance data provided to the UE 102).

The GMLC 160 may support a location request for the UE 102 received from an external client 130 and may forward such a location request to a serving AMF 154 for UE 102. The AMF 154 may then forward the location request to either gNB 110-1 or LMF 152 which may obtain one or more location estimates for UE 102 (e.g. according to the request from external client 130) and may return the location estimate(s) to AMF 154, which may return the location estimate(s) to external client 130 via GMLC 160. GMLC 160 may contain subscription information for an external client 130 and may authenticate and authorize a location request for UE 102 from external client 130. GMLC 160 may further initiate a location session for UE 102 by sending a location request for UE 102 to AMF 154 and may include in the location request an identity for UE 102 and the type of location being requested (e.g. such as a current location or a sequence of periodic or triggered locations).

As further illustrated in FIG. 1, an external client 130 may be connected to the core network 150 via the GMLC 160 and/or the SLP 162. The external client 130 may optionally be connected to the core network 150 and/or to an SLP 164, that is external to 5GCN 150, via the Internet 175. The external client 130 may be a server, a web server, or a user device, such as a personal computer, a UE, etc.

The LMF 152 and the gNB 110-1 may communicate using a New Radio Positioning Protocol A (NRPPa). NRPPa may be defined in 3GPP TS 38.455, with NRPPa messages being transferred between the gNB 110-1 and the LMF 152. Further, the LMF 152 and UE 102 may communicate using the LTE Positioning Protocol (LPP) defined in 3GPP TS 37.355, where LPP messages are transferred between the UE 102 and the LMF 152 via the serving AMF 154 and the serving gNB 110-1 for UE 102. For example, LPP messages may be transferred between the AMF 154 and the UE 102 using a 5G Non-Access Stratum (NAS) protocol. The LPP protocol may be used to support positioning of UE 102 using UE assisted and/or UE based position methods such as Assisted GNSS (A-GNSS), Real Time Kinematic (RTK), Wireless Local Area Network (WLAN), Observed Time Difference of Arrival (OTDOA), DL-TDOA, Round-Trip Time (RTT), multi-RTT, and/or Enhanced Cell Identity (ECID). The NRPPa protocol may be used to support positioning of UE 102 using network based position methods such as ECID (when used with measurements obtained by or received from a gNB 110-1, 110-2, 110-3, or ng-eNB 114) and/or may be used by LMF 152 to obtain location related information from gNBs such as parameters defining positioning reference signal (PRS) transmission from gNBs for support of DL-TDOA.

GNBs 110-1, 110-2, 110-3, or ng-eNB 114 may communicate with AMF 154 using a Next Generation Application Protocol (NGAP), e.g. as defined in 3GPP TS 38.413, or using a location specific protocol (referred to here as LSP1) transported by NGAP. NGAP or the LSP1 may enable AMF 154 to request a location of a UE 102 from a gNB 110-1 for UE 102 and may enable gNB 110-1 to return a location for UE 102 to the AMF 154.

GNBs 110-1, 110-2, 110-3, or ng-eNB 114 may communicate with one another using an Xn Application Protocol (XnAP), e.g. as defined in 3GPP TS 38.423, or using a location specific protocol (referred to here as LSP2) transported by XnAP, which may be different to LSP1. XnAP or LSP2 may allow one gNB to request another gNB to obtain UL location measurements for a UE and to return the UL location measurements. XnAP or LSP2 may also enable a gNB to request another gNB to transmit a downlink (DL) RS or PRS to enable a UE 102 to obtain DL location measurements of the transmitted DL RS or PRS. In some embodiments, LSP2 (when used) may be same as or an extension to NRPPa.

A gNB (e.g. gNB 110-1) may communicate with a UE 102 using a Radio Resource Control (RRC) protocol, e.g. as defined in 3GPP TS 38.331, or using a location specific protocol (referred to here as LSP3) transported by RRC, which may be different to LSP1 and LSP2. RRC or LSP3 may allow a gNB (e.g. gNB 110-1) to request location measurements from the UE 102 of DL RSs or DL PRSs transmitted by the gNB 110-1 and/or by other gNBs 110-2, 110-3, or ng-eNB 114 and to return some or all of the location measurements. RRC or LSP3 may also enable a gNB (e.g. gNB 110-1) to request the UE 102 to transmit an UL RS or PRS to enable the gNB 110-1 or other gNBs 110-2, 110-3, or ng-eNB 114 to obtain UL location measurements of the transmitted UL RS or PRS. In some embodiments, LSP3 (when used) may be same as or an extension to LPP.

With a UE assisted position method, UE 102 may obtain location measurements (e.g. measurements of RSSI, RxTx, RTT, Multi-RTT, AoA, RSTD, RSRP and/or RSRQ for gNBs 110-1, 110-2, 110-3, or ng-eNB 114 or WLAN APs, or measurements of GNSS pseudorange, code phase and/or carrier phase for SVs 190) and send the measurements to an entity performing a location server function, e.g., LMF 152, or SLP 162, for computation of a location estimate for UE 102. With a UE based position method, UE 102 may obtain location measurements (e.g. which may be the same as or similar to location measurements for a UE assisted position method) and may compute a location of UE 102 (e.g. with the help of assistance data received from a location server such as LMF 152 or SLP 162). With a network based position method, one or more base stations (e.g. gNBs 110-1-110-2) or APs may obtain location measurements (e.g. measurements of RSSI, RTT, AOD, RSRP, RSRQ, RxTx or TOA for signals transmitted by UE 102) and/or may receive measurements obtained by UE 102, and may send the measurements to a location server, e.g., LMF 152 or SLP 162, for computation of a location estimate for UE 102.

Information provided by the gNBs 110-2, 110-3, or ng-eNB 114 to the gNB 110-1 using XnAP or LSP2 may include timing and configuration information for PRS transmission and location coordinates of the gNBs 110-2, 110-3, or ng-eNB 114. The gNB 110-1 can then provide some or all of this information to the UE 102 as assistance data in an RRC or LSP3 message. An RRC message sent from gNB 110-1 to UE 102 may include an embedded LSP3 message (e.g. an LPP message) in some implementations.

An RRC or LSP3 message sent from the gNB 110-1 to the UE 102 may instruct the UE 102 to do any of a variety of things, depending on desired functionality. For example, the RRC or LSP3 message could contain an instruction for the UE 102 to obtain measurements for GNSS (or A-GNSS), WLAN, and/or DL-TDOA (or some other position method) or to transmit uplink (UL) signals, such as Positioning Reference Signals, Sounding Reference Signals, or both. In the case of DL-TDOA, the RRC or LSP3 message may instruct the UE 102 to obtain one or more measurements (e.g. RSTD measurements) of PRS signals transmitted within particular cells supported by particular gNBs. The UE 102 may use the measurements to determine the position of UE 102, e.g., using DL-TDOA.

A gNB in NG-RAN 112 may also broadcast positioning assistance data to UEs such as UE 102.

As illustrated, a Session Management Function (SMF) 156 connects the AMF 154 and the UPF 158. The SMF 156 may have the capability to control both a local and a central UPF within a PDU session. SMF 156 may manage the establishment, modification, and release of PDU sessions for UE 102, perform IP address allocation and management for UE 102, act as a Dynamic Host Configuration Protocol (DHCP) server for UE 102, and select and control a UPF 158 on behalf of UE 102.

The User Plane Function (UPF) 158 may support voice and data bearers for UE 102 and may enable UE 102 voice and data access to other networks such as the Internet 175. UPF 158 functions may include: external PDU session point of interconnect to a Data Network, packet (e.g. Internet Protocol (IP)) routing and forwarding, packet inspection and user plane part of policy rule enforcement, Quality of Service (QOS) handling for user plane, downlink packet buffering and downlink data notification triggering. UPF 158 may be connected to SLP 162 to enable support of location of UE 102 using SUPL. SLP 162 may be further connected to or accessible from external client 130.

It should be understood that while FIG. 1 shows a network architecture for a non-roaming UE, with suitable, well-known, changes, a corresponding network architecture may be provided for a roaming UE.

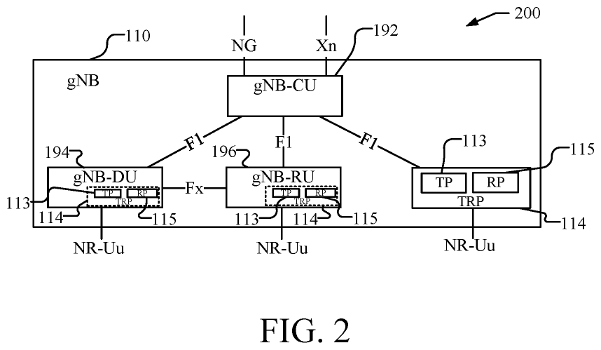

FIG. 2 shows an architecture diagram of an NG-RAN node 200 that may be within an NG-RAN 112 in FIG. 1, e.g., as a separate entity or as part of another gNB. The NG-RAN node 200 may be a gNB 110, according to one implementation. The architecture shown in FIG. 2, for example, may be applicable to any gNB 110 in FIG. 1.

As illustrated, gNB 110 may include a gNB Central Unit (gNB-CU) 192, a gNB Distributed Unit (gNB-DU) 194, a gNB Remote Unit (gNB-RU) 196, which may be physically co-located in the gNB 110 or may be physically separate. The gNB-CU 192 is a logical or physical node hosting support for Radio Resource Control (RRC), Service Data Adaptation Protocol (SDAP) and Packet Data Convergence Protocol (PDCP) protocols of the gNB 110 used over the NR Uu air interface and controlling the operation of one or more gNB-DUs and/or gNB-RUs. The gNB-CU 192 terminates an F1 interface connected with a gNB-DU and in some implementations, an F1 interface connected with a gNB-RU. As illustrated, the gNB-CU 192 may communicate with an AMF via an NG interface. The gNB-CU 192 may further communicate with one or more other gNBs 110 via an Xn interface. The gNB-DU 194 is a logical or physical node hosting support for Radio Link Control (RLC), Medium Access Control (MAC) and Physical (PHY) protocol layers used over the NR Uu air interface of the gNB 110, operation of which is partly controlled by gNB-CU 192. The gNB-DU terminates the F1 interface connected with the gNB-CU 192, and may terminate a lower layer split point interface Fx with a gNB-RU. The gNB-RU 196 may be based on a lower layer function split and is a logical or physical node hosting support for lower layer functions, such as PHY and Radio Frequency (RF) protocol layers used over the NR Uu air interface of the gNB 110, operation of which is partly controlled by gNB-CU 192 and/or gNB-DU 194. The gNB-RU 196 terminates the Fx interface connected with the gNB-DU 194 and in some implementations may terminate the F1 interface connected with the gNB-CU 192.

The gNB-CU 192 requests positioning measurements (e.g. E-CID) to the gNB-DU 194 and/or gNB-RU 196. The gNB-DU 194 and/or gNB-RU 196 may report the measurements back to the gNB-CU 192. A gNB-DU 194 or gNB-RU 196 may include positioning measurement functionality. It should be understood that a separate measurement node is not precluded.

Additionally, as illustrated in FIG. 2, gNB 110 may include a Transmission Point (TP) 113 and a Reception Point (RP) 115 combined into a Transmission Reception Point (TRP) 114, which may be physically or logically located in the gNB 110. The gNB-CU 192 may be configured to communicate with the TP 113 and RP 115, e.g., via F1 interfaces. The gNB-CU 192, thus, controls one or more TPs 113 and RPs 115 which are accessible from the gNB-CU 192 via an F1 interface.

In some embodiments, the NG-RAN node 200 (or gNB 110) may comprise a subset of the elements shown in FIG. 2. For example, the NG-RAN node 200 may comprise the gNB-CU 192 but may not include one or more of gNB-DU 194 and gNB-RU 196, RP 115 or TP 113. Alternatively, NG-RAN node 200 may include one or more of gNB-DU 194 and, RP 115 or TP 113 but may not include gNB-RU 196. Further, the elements shown in FIG. 2 may be logically separate but physically co-located or may be partially or completely physically separate. For example, one or more of gNB-DU 194 and/or gNB-RU 196, RP 115 or TP 113 may be physically separate from gNB-CU 192 or may be physically combined with gNB-CU 192. In the case of physical separation, the F1 or Fx interface may define signaling over a physical link or connection between two separated elements. In some implementations, gNB-CU 192 may be split into a control plane portion (referred to as a CU-CP or gNB-CU-CP) and a user plane portion (referred to as CU-UP or gNB-CU-UP). In this case, both the gNB-CU-CP and gNB-CU-UP may interact with gNB-DU 194 and/or gNB-RU 196 to support NR Uu air interface signaling for control plane and user plane, respectively. However, only the gNB-CU-CP may interact with TPs 113 and RPs 115 to support and control location related communication.

Protocol layering between the gNB-CU 192 and the TP 113, and RP 115 may be based on F1 C as defined in 3GPP TS 38.470, which uses an F1 Application Protocol (F1AP) at the top level as specified in 3GPP TS 38.473. New messages to support positioning could be added directly into F1AP or could be introduced in a new location specific protocol which is transported using F1AP.

The location procedures with the gNB-CU 192 may comprise all location related procedures on NG, Xn, and NR-Uu interfaces. For example, the location procedures between AMF 154 and the NG-RAN node 200 may use NGAP. The location procedures between NG-RAN node 200 and other NG-RAN nodes, e.g., gNBs 110, may use XnAP or a protocol above XnAP, such as an extended NR Positioning Protocol A (NRPPa) as defined in 3GPP TS 38.455. The location procedures between NG-RAN node 200 and UE 102 may use RRC and/or LPP.

The corresponding messages to support positioning may be carried inside a transparent F1AP message transfer container. For example, the Transfer of an NGAP Location Reporting Control and NAS Transport message may be carried in an UL/DL NGAP Message Transfer. The Transfer of location related XnAP messages may be carried in an UL/DL XnAP Message Transfer. The Transfer of location related RRC (LPP) messages may be carried in an UL/DL RRC (LPP) Message Transfer.

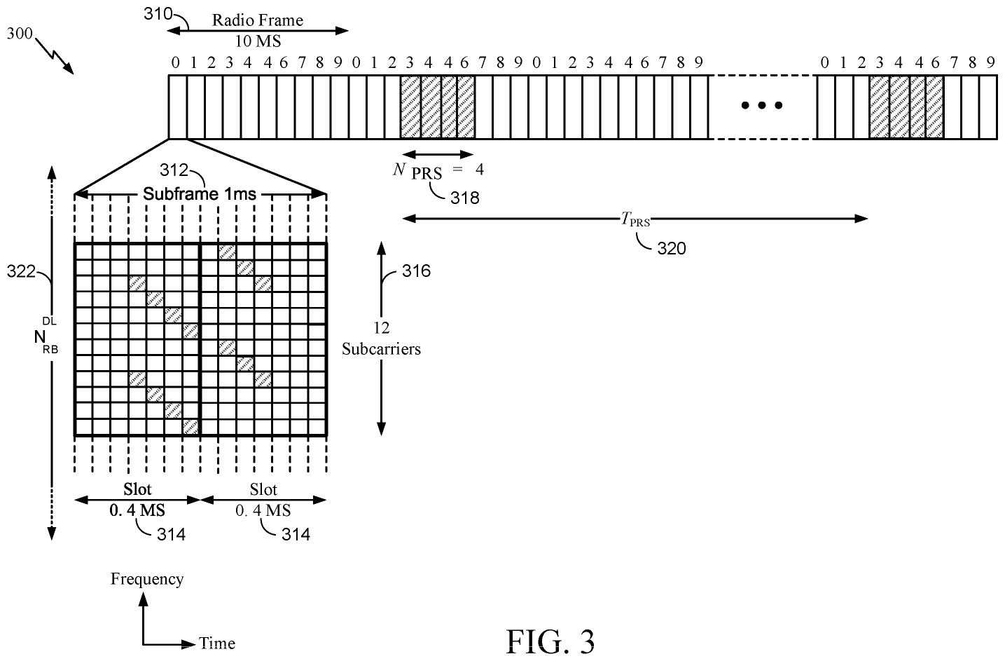

FIG. 3 shows a structure of an exemplary subframe sequence 300 with positioning reference signal (PRS) positioning occasions, according to aspects of the disclosure. Subframe sequence 300 may be applicable to the broadcast of PRS signals from a base station (e.g., any of the base stations described herein) or other network node. The subframe sequence 300 may be used in LTE systems, and the same or similar subframe sequence may be used in other communication technologies/protocols, such as 5G and NR. In FIG. 3, time is represented horizontally (e.g., on the X axis) with time increasing from left to right, while frequency is represented vertically (e.g., on the Y axis) with frequency increasing (or decreasing) from bottom to top. As shown in FIG. 3, downlink and uplink radio frames 310 may be of 10 millisecond (ms) duration each. For downlink frequency division duplex (FDD) mode, radio frames 310 are organized, in the illustrated example, into ten subframes 312 of 1 ms duration each. Each subframe 312 comprises two slots 314, each of, for example, 0.5 ms duration.

In the frequency domain, the available bandwidth may be divided into uniformly spaced orthogonal subcarriers 316 (also referred to as “tones” or “bins”). For example, for a normal length cyclic prefix (CP) using, for example, 15 kHz spacing, subcarriers 316 may be grouped into a group of twelve (12) subcarriers. A resource of one OFDM symbol length in the time domain and one subcarrier in the frequency domain (represented as a block of subframe 312) is referred to as a resource element (RE). Each grouping of the 12 subcarriers 316 and the 14 OFDM symbols is termed a resource block (RB) and, in the example above, the number of subcarriers in the resource block may be written as N_{SC}^{RB}=12. For a given channel bandwidth, the number of available resource blocks on each channel 322, which is also called the transmission bandwidth configuration 322, is indicated as N_{RB}^{DL}. For example, for a 3 MHz channel bandwidth in the above example, the number of available resource blocks on each channel 322 is given by N_{RB}^{DL}=15. Note that the frequency component of a resource block (e.g., the 12 subcarriers) is referred to as a physical resource block (PRB).

A base station may transmit radio frames (e.g., radio frames 310), or other physical layer signaling sequences, supporting PRS signals (i.e. a downlink (DL) PRS) according to frame configurations either similar to, or the same as that, shown in FIG. 3, which may be measured and used for a UE (e.g., any of the UEs described herein) position estimation. Other types of wireless nodes (e.g., a distributed antenna system (DAS), remote radio head (RRH), UE, AP, etc.) in a wireless communications network may also be configured to transmit PRS signals configured in a manner similar to (or the same as) that depicted in FIG. 3.

A collection of resource elements that are used for transmission of PRS signals is referred to as a “PRS resource.” The collection of resource elements can span multiple PRBs in the frequency domain and N (e.g., 1 or more) consecutive symbol(s) within a slot 314 in the time domain. For example, the cross-hatched resource elements in the slots 314 may be examples of two PRS resources. A “PRS resource set” is a set of PRS resources used for the transmission of PRS signals, where each PRS resource has a PRS resource identifier (ID). In addition, the PRS resources in a PRS resource set are associated with the same transmission-reception point (TRP). A PRS resource ID in a PRS resource set is associated with a single beam transmitted from a single TRP (where a TRP may transmit one or more beams). Note that this does not have any implications on whether the TRPs and beams from which signals are transmitted are known to the UE.

PRS may be transmitted in special positioning subframes that are grouped into positioning occasions. A PRS occasion is one instance of a periodically repeated time window (e.g., consecutive slot(s)) where PRS are expected to be transmitted. Each periodically repeated time window can include a group of one or more consecutive PRS occasions. Each PRS occasion can comprise a number N_{PRS} of consecutive positioning subframes. The PRS positioning occasions for a cell supported by a base station may occur periodically at intervals, denoted by a number T_{PRS} of milliseconds or subframes. As an example, FIG. 3 illustrates a periodicity of positioning occasions where N_{PRS} equals 4 318 and T_{PRS} is greater than or equal to 20 320. In some aspects, T_{PRS} may be measured in terms of the number of subframes between the start of consecutive positioning occasions. Multiple PRS occasions may be associated with the same PRS resource configuration, in which case, each such occasion is referred to as an “occasion of the PRS resource” or the like.

A PRS may be transmitted with a constant power. A PRS can also be transmitted with zero power (i.e., muted). Muting, which turns off a regularly scheduled PRS transmission, may be useful when PRS signals between different cells overlap by occurring at the same or almost the same time. In this case, the PRS signals from some cells may be muted while PRS signals from other cells are transmitted (e.g., at a constant power). Muting may aid signal acquisition and time of arrival (TOA) and reference signal time difference (RSTD) measurement, by UEs, of PRS signals that are not muted (by avoiding interference from PRS signals that have been muted). Muting may be viewed as the non-transmission of a PRS for a given positioning occasion for a particular cell. Muting patterns (also referred to as muting sequences) may be signaled (e.g., using the LTE positioning protocol (LPP)) to a UE using bit strings. For example, in a bit string signaled to indicate a muting pattern, if a bit at position j is set to ‘0’, then the UE may infer that the PRS is muted for a jth positioning occasion.

To further improve hearability of PRS, positioning subframes may be low-interference subframes that are transmitted without user data channels. As a result, in ideally synchronized networks, PRS may be interfered with by other cells' PRS with the same PRS pattern index (i.e., with the same frequency shift), but not from data transmissions. The frequency shift may be defined as a function of a PRS ID for a cell or other transmission point (TP) (denoted as N_{ID}^{PRS}) or as a function of a physical cell identifier (PCI) (denoted as N_{ID}^{cell}) if no PRS ID is assigned, which results in an effective frequency re-use factor of six (6).

To also improve hearability of a PRS (e.g., when PRS bandwidth is limited, such as with only six resource blocks corresponding to 1.4 MHz bandwidth), the frequency band for consecutive PRS positioning occasions (or consecutive PRS subframes) may be changed in a known and predictable manner via frequency hopping. In addition, a cell supported by a base station may support more than one PRS configuration, where each PRS configuration may comprise a distinct frequency offset (vshift), a distinct carrier frequency, a distinct bandwidth, a distinct code sequence, and/or a distinct sequence of PRS positioning occasions with a particular number of subframes (N_{PRS}) per positioning occasion and a particular periodicity (T_{PRS}). In some implementation, one or more of the PRS configurations supported in a cell may be for a directional PRS and may then have additional distinct characteristics, such as a distinct direction of transmission, a distinct range of horizontal angles, and/or a distinct range of vertical angles.

A PRS configuration, as described above, including the PRS transmission/muting schedule, is signaled to the UE to enable the UE to perform PRS positioning measurements. The UE is not expected to blindly perform detection of PRS configurations.

Note that the terms “positioning reference signal” and “PRS” may sometimes refer to specific reference signals that are used for positioning in LTE/NR systems. However, as used herein, unless otherwise indicated, the terms “positioning reference signal” and “PRS” refer to any type of reference signal that can be used for positioning, such as but not limited to, PRS signals in LTE/NR, navigation reference signals (NRS), transmitter reference signals (TRS), cell-specific reference signals (CRS), channel state information reference signals (CSI-RS), primary synchronization signals (PSS), secondary synchronization signals (SSS), etc.

Similar to DL PRS transmitted by base stations, discussed above, a UE may transmit UL PRS for positioning. The UL PRS may be, e.g., sounding reference signals (SRS) for positioning. Using received DL PRS from base stations, the UE may perform various positioning measurement, such as RSTD, RSRP, and Rx-Tx measurements that may be used in DL positioning methods, such as DL-TDOA, and DL AOD, and in combined DL and UL positioning methods such as RTT and multi-cell RTT. Using received UL PRS (e.g. SRS) from the UE, the base stations may perform various positioning measurements, such as RSTD and Rx-Tx, which may be used in UL positioning methods, such as UL-TDOA, UL-AOA, and in combined DL and UL positioning methods such as RTT and multi-cell RTT.

Similar to DL PRS, which may include a number N_{PRS} 318 of consecutive positioning subframes and a periodicity T_{PRS} of positioning occasions 320, as illustrated in FIG. 3, UL PRS (i.e., SRS for positioning) may likewise include a number N_{SRS} of consecutive positioning subframes and a periodicity T_{SRS} of positioning occasions, where T_{SRS} is greater than or equal to N_{SRS}. In some aspects, the periodicity T_{PRS} may be measured in terms of the number of subframes between the start of consecutive positioning occasions. Multiple periodic SRS occasions may be associated with the same SRS resource configuration, in which case, each such occasion is referred to as an “occasion of the SRS resource” or the like.

As per release 16 from 3GPP TS 38.331, SRS positioning (sometimes referred to as SRS-Pos) resources (SRS-PosResource) can be configured to be periodic, semi-persistent, or aperiodic. The configuration for the SRS positioning resources provided to the UE 102 is specified in the information element (IE) resourceType-r16, illustrated in Table 1.

TABLE 1

| | |
|---|---|
| resourceType-r16 | CHOICE { |
| aperiodic-r16 | SEQUENCE { |
| slotOffset-r16 | INTEGER (1 ...32) |

```
    ...
  },
```

| | |
|---|---|
| semi-persistent-r16 | SEQUENCE { |
| periodicityAndOffset_sp-r16 | SRS-PeriodicityAndoffset_sp-r16, |

```
    ...
  },
```

| | |
|---|---|
| periodic-r16 | SEQUENCE { |
| periodicityAndOffset_p-r16 | SRS-PeriodicityAndoffset_sp-r16, |

```
    ...
  },
},
```

The configuration for periodic SRS transmissions is provide by the base station 110 to the UE 102 in RRC signaling. As noted above, for example, the periodic SRS transmissions may be configured with a periodicity T_{SRS} so that multiple periodic SRS occasions are associated with the same SRS resource configuration. An RRC message is provided by the base station 110 to the UE 102 to activate the periodic SRS transmissions and a separate RRC message is required to stop the transmission of the periodic SRS resources.

For semi-persistent SRS transmissions, the configuration is provided by the base station 110 to the UE 102 in Medium Access Control-Control Element (MAC-CE) signaling, which is required to activate and deactivate the transmission of SRS resources by the UE 102.

For aperiodic SRS transmissions, the configuration is provided by the base station 110 to the UE 102 in a Downlink Control Information (DCI) message, which is required to activate the one time transmission of SRS resources.

It is sometimes desirable for positioning to have a set of SRS resources transmitted by the UE 102 within a specific time window, which may have its own repetition interval. For example, in some cases, it may be desired for the UE 102 to transmit one or more SRS transmissions (e.g., periodic SRS transmissions having a periodicity T_{SRS}) for measurement by one or more base stations 110 within a known time window, and the time window may be repeated with its own periodicity.

The use of a specific window for SRS transmissions, for example, may be similar to the requestedLocationTime-r17, proposed in Release 17, which specifies the reporting window during which positioning measurements should be reported. The requestedLocationTime-r17, for example, may provide a desired measurement time (desiredLocationTime-r17), and an allowed uncertainty of the requested location time (timeUncertainty-r17).

The SRS transmission within a specified window, however, whether the SRS resources are periodic, semi-persistent, or aperiodic, are required to be activated and deactivated as discussed above. Accordingly, where repetition of the window for SRS transmissions is desired, additional signaling is required to activate and deactivate the SRS transmissions within each transmissions window, despite knowing apriori when the SRS transmissions should occur for each transmissions window.

Moreover, SRS transmission while the UE 102 is in RRC Inactive mode may be desired. The UE 102 may be placed in RRC Inactive mode using an RRC release message. The RRC release message may carry the SRS configuration for the UE 102, once in Inactive mode the UE 102 may only receive paging messages. While in Inactive mode, the UE 102 cannot receive MAC-CE or DCI messages, which are required to activate and deactivate semi-persistent SRS transmissions or aperiodic SRS transmissions. Additionally, the UE 102 will still require separate RRC messages to start and stop each periodic SRS transmission while in Inactive mode, rendering SRS transmission in Inactive mode inefficient.

As discussed herein, in some implementations, an SRS resource type may be configured to enable a UE 102 to repeatedly transmit a set of SRS resources at apriori known times without requiring messaging to activate and deactivate the transmission of SRS resources in each set of SRS resources. Each set of SRS resources, where each set may include, e.g., periodic, semi-persistent, or aperiodic SRS transmissions, is sometimes referred to herein as a “burst” of SRS resources. The repeating sets of SRS resources may sometimes be referred to herein as a periodic burst of SRS resources. Thus, the SRS positioning resources (SRS-PosResource), e.g., as provided in a resourceType IE, may be denoted as a burst or periodic burst, in addition to periodic, semi-persistent, or aperiodic.

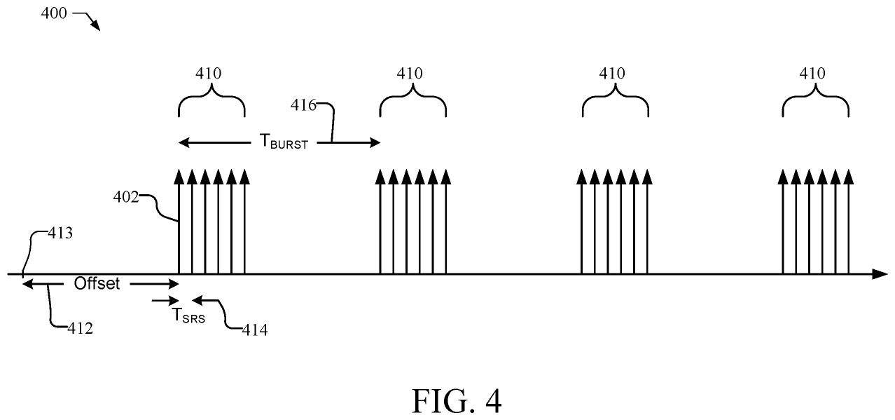

FIG. 4 schematically illustrates a configuration for periodic burst of SRS resources 400, shown as repeating sets of repeating SRS resources. As illustrated, the periodic burst of SRS resources 400 includes a plurality of sets (or bursts) 410 of SRS resources, where within each set 410, there are one or more SRS resources 402, illustrated as a vertical arrow.

The configuration for the periodic burst of SRS resources 400 may be configured with a start time, the SRS resource repetition within each set 410, and the repetition of the set 410. For example, FIG. 4 illustrates the start time for the periodic burst of SRS resources 400 with an Offset 412 from a predetermined time or slot 413. The SRS resource repetition rate with each set 410 is illustrated with the SRS period T_{SRS} 414 within a set. Moreover, repetition of the set 410 is illustrated with burst period T_{BURST} 416.

With the periodic burst of SRS resources 400, the UE 102 may transmit set of SRS resources in a burst manner. The repetition of SRS resources 402 within each set 410, e.g., with the SRS period T_{SRS} 414, may be used to satisfy a location request at a specific time, e.g., within a specified time window. The repetition of the set 410, e.g., with burst period T_{BURST} 416, satisfies the repetition of the location request.

In some implementations, the periodic burst of SRS resources may be triggered using, e.g. an RRC message, which may be used to configure and activate the periodic burst of SRS resources. In some implementations, the periodic burst of SRS resources may be deactivated using an RRC reconfiguration message. In another implementation, the periodic burst of SRS resources may be triggered (activated) with a MAC-CE message and deactivated with another MAC-CE message, but MAC-CE messages are not necessary to activate and deactivate each individual burst.

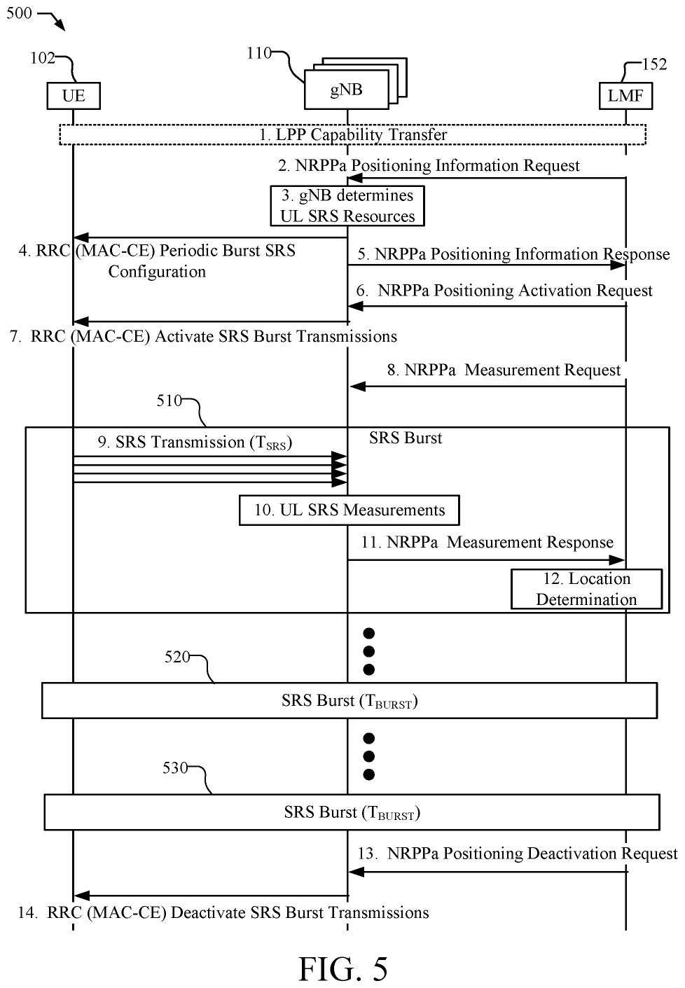

FIG. 5 is a message flow 500 illustrating messaging between the LMF 152, the gNBs 110, and the UE 102 for UE positioning using periodic burst SRS resources, as described herein. The gNBs 110 may include a serving gNB and multiple neighboring gNBs. For the sake of simplicity, FIG. 5 illustrates signaling to and from the gNBs 110 collectively, but it should be understood that each gNB may individually receive and transmit one or more of the signal illustrated in FIG. 5 unless addressed otherwise. Additionally, while FIG. 5 illustrates the use of gNBs 110 serving as base stations for the UE 102 and LMF 152 serving as a location server, it should be understood that the positioning is not so limited and that the position procedure may use different types of base stations, such as eNBs, or location servers, such as SLP, E-SMLC, or location servers completely or partially located within the base station may be used.

The procedure illustrated in FIG. 5 uses UL SRS and may support UL position methods such as UL-TDOA or UL-AOA in which gNBs 110 measure UL SRS signals from UE 102, and the UE 102 does not measure DL PRS signals from gNBs 110 or other DL signals (e.g. from SVs 190 or a WLAN AP). It should be understood that in some implementations, DL PRS may also be used in conjunction with the UL SRS, e.g., to support combined UL and DL positioning methods such as multi-cell RTT (also referred to as multi-RTT) in which UE 102 obtains DL measurements and gNBs 110 obtain UL measurements, or DL positioning methods (such as DL-TDOA, DL-AOD, A-GNSS, etc.) used in conjunction with UL positioning methods. It should be further understood that the signaling illustrated in FIG. 5 is for the sake of example, and that in some implementations additional messages, different messages, or fewer messages may be used for UE positioning using periodic burst SRS resources. Further, additional messaging may be included, e.g. for RRC registration and connection, and entering and exiting an RRC Inactive mode, including an RRC release message and an RRC reconfiguration message.

At stage 1, the LMF 152 may optionally request the positioning capabilities of the UE 102 (e.g., if not already obtained) using a LPP Capability Transfer procedure, and the UE 102 may provide its capabilities to the LMF 152, e.g., in an LPP Provide Capabilities message, e.g., described in 3GPP TS 38.305.

At stage 2, the LMF 152 may send a NRPPa Positioning Information Request message to the serving gNB 110 to request UL information for the UE 102. The LMF 152 may provide an indication that periodic burst SRS is desired, e.g., by indicating a location request for the UE 102 at a specific time, e.g., location measurements are desired within a time window, and an indication of a repetition of the location request. In some implementations, the indication that periodic burst SRS is desired may be provided to the gNB 110 in a separate message.

At stage 3, the serving gNB 110 may determine the resources available for UL SRS that will satisfy the location request received from the LMF 152.

At stage 4, the serving gNB 110 may configure the UE 102 for the periodic burst SRS resources using an RRC message as described herein. In some implementations, the configuration for the periodic burst SRS resources may be provided in an MAC-CE message. The serving gNB 110, for example, may provide the UE 102 with a periodic burst SRS resources configuration that includes a start time, the SRS resource repetition within each burst, and the repetition of the burst. For example, as discussed in FIG. 4, the configuration may include a starting slot or slot offset to start the SRS transmissions, the SRS period T_{SRS} within a burst, and the burst period T_{BURST}. It should be understood that while the configuration for the periodic burst SRS resources is illustrated as being provided by the serving gNB 110 in RRC (or MAC-CE) message, in some implementations, the configuration may be provided by the LMF 152 (or other network entity) and may be sent to the UE 102 via the serving gNB 110, e.g., in an LPP message.

At stage 5, the serving gNB 110 provides the UL SRS configuration information to the LMF 152 in a NRPPa Positioning Information Response message.

At stage 6, the LMF 152 may send an NRPPa Positioning Activation Request message to the serving gNB 110 to activate the UL SRS transmission from UE 102.

At stage 7, the serving gNB 110 may activate the periodic burst of SRS transmissions, e.g., with an RRC or MAC-CE (or other) message. In some implementations, if not already provided, e.g., in stage 4, the serving gNB 110 may configure the UE 102 for the periodic burst SRS resources using an RRC (or MAC-CE) message as described in stage 4. The serving gNB 110 may return an NRPPa acknowledgment to the LMF 152, which may include the periodic burst SRS resource configuration (not shown in FIG. 5). In some implementations, e.g., where the UE 102 is going to enter an RRC Inactive mode, the activation of the periodic burst of SRS transmissions in stage 7 may be included in an RRC release message prior to the UE entering the RRC Inactive mode.

At stage 8, the LMF 152 may provide a request for UL measurement with the UL information including the periodic burst SRS configuration to selected gNBs 110 in a NRPPa MEASUREMENT REQUEST message. In some implementations, the serving gNB 110 may provide the periodic burst SRS configuration to the selected gNBs 110, e.g., in Xn messaging.

Block 510, including stages 9-12, illustrates a single SRS burst, e.g., one set of UL SRS resources transmitted by the UE 102 and measured by one or more base stations. The SRS burst in block 510 may occur while the UE 102 remains in an RRC Connected mode, or in some implementations, after the UE 102 has entered an RRC Inactive mode, e.g., after an RRC release message (e.g., in stage 7 or elsewhere).

At stage 9, the UE 102 transmits the SRS resources with the configured periodicity T_{SRS}, illustrated with multiple arrows. It should be understood that while FIG. 5 illustrates a single set of periodic SRS resources to all of the gNBs 110, in some implementations, the UE 102 may transmit periodic SRS resources to each gNB 110 individually.

At stage 10, each gNB 110 configured at stage 8 measures the periodic SRS transmissions from the UE 102.

At stage 11, the gNBs 110 report the SRS measurements to the LMF 152 in NRPPa Measurement Response messages.

At stage 12, the LMF 152 uses received measurements from stage 11 (and any DL measurements received from the UE 102 (not shown) to determine the positioning information and location of the UE 102. For example, the LMF 152 may determine the location of the UE 102 based on UL-TDOA, UL-AOA, multi-RTT (if DL measurements are provided) etc.

As illustrated by blocks 520 and 530, the SRS burst, as described in block 510, may be repeated with the configured periodicity T_{BURST}. Thus, within each SRS burst in blocks 520 and 530, the UE 102 transmits the SRS resources with the configured periodicity T_{SRS}, which are measured by the gNBs 110, and the measurements are provided to the LMF 152 for location determination of the UE 102 for each SRS burst.

At stage 13, the LMF 152 may send an NRPPa Positioning Deactivation Request message to the serving gNB 110 to deactivate the UL SRS transmission from UE 102.

At stage 14, the serving gNB 110 may deactivate the periodic burst of SRS transmissions, e.g., with an RRC or MAC-CE (or other) message. In some implementations, e.g., where the UE 102 is in an RRC Inactive mode, the deactivation of the periodic burst of SRS transmissions may be included in an RRC reconfiguration message. It should be understood that while the deactivation of the periodic burst SRS resources is illustrated as being provided by the serving gNB 110 in an RRC (or MAC-CE) message, in some implementations, the deactivation may be provided by the LMF 152 (or other network entity) and may be sent to the UE 102 via the serving gNB 110, e.g., in an LPP message.

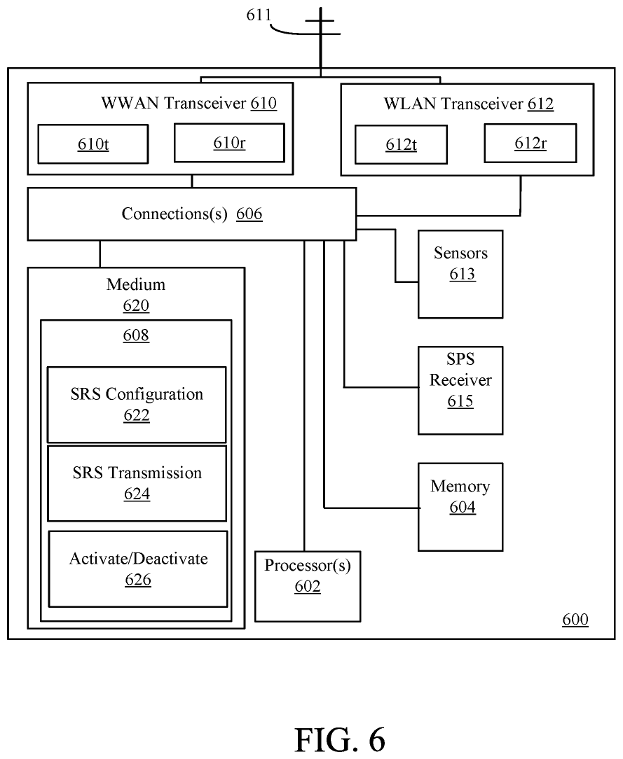

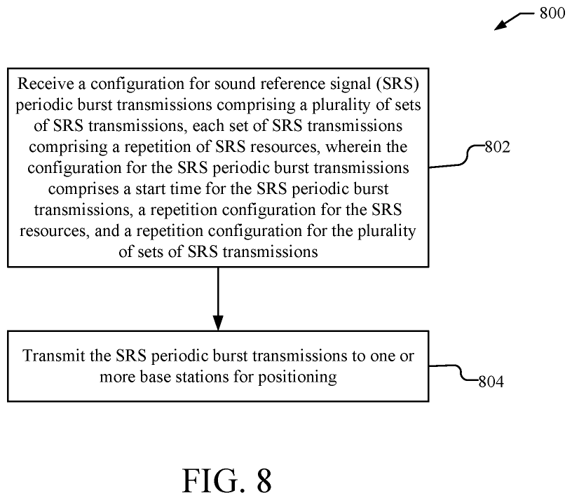

FIG. 6 shows a schematic block diagram illustrating certain exemplary features of a UE 600, e.g., which may be UE 102 shown in FIG. 1 and FIG. 5, that is configured to support UE positioning using periodic burst SRS resources, as discussed herein. The UE 600, for example, may perform the signal flows shown in FIG. 5 and the process flow shown in FIG. 8 and algorithms disclosed herein. The UE 600 may, for example, include one or more processors 602, memory 604, an external interface such as at least one wireless transceiver (e.g., wireless network interface) illustrated as Wireless Wide Area Network (WWAN) transceiver 610 and Wireless Local Area Network (WLAN) transceiver 612, SPS receiver 615, and one or more sensors 613, which may be operatively coupled with one or more connections 606 (e.g., buses, lines, fibers, links, etc.) to non-transitory computer readable medium 620 and memory 604. The wireless transceiver (e.g. WWAN wireless transceiver 610 and/or WLAN wireless transceiver 612) may further include transceivers for Wireless Personal Area Network (WPAN), Wireless Metropolitan Area Network (WMAN), etc. The SPS receiver 615, for example, may receive and process SPS signals from SVs 190 shown in FIG. 1. The one or more sensors 613, for example, may include a barometer and/or an inertial measurement unit (IMU) that may include one or more accelerometers, one or more gyroscopes, a magnetometer, etc. The UE 600 may further include additional items, which are not shown, such as a user interface that may include e.g., a display, a keypad or other input device, such as virtual keypad on the display, through which a user may interface with the UE. In certain example implementations, all or part of UE 600 may take the form of a chipset, and/or the like.

The at least one wireless transceiver may be a wireless transceiver 610 for a WWAN communication system and a wireless transceiver 612 for a WLAN communication system, or may be a combined wireless transceiver for both WWAN and WLAN. The WWAN wireless transceiver 610 may include a transmitter 610t and receiver 610r coupled to one or more antennas 611 for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The WLAN wireless transceiver 612 may include a transmitter 612t and receiver 612r coupled to one or more antennas 611 or to separate antennas, for transmitting (e.g., on one or more uplink channels and/or one or more sidelink channels) and/or receiving (e.g., on one or more downlink channels and/or one or more sidelink channels) wireless signals and transducing signals from the wireless signals to wired (e.g., electrical and/or optical) signals and from wired (e.g., electrical and/or optical) signals to the wireless signals. The transmitters 610t and 612t may include multiple transmitters that may be discrete components or combined/integrated components, and/or the receivers 610r and 612r may include multiple receivers that may be discrete components or combined/integrated components. The WWAN wireless transceiver 610 may be configured to communicate signals (e.g., with base stations and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), etc. New Radio (NR) may use mm-wave frequencies and/or sub-6 GHZ frequencies. The WLAN wireless transceiver 612 may be configured to communicate signals (e.g., with access points and/or one or more other devices) according to a variety of radio access technologies (RATs) such as 3GPP LTE-V2X (PC5), IEEE 802.11 (including IEEE 802.11p), WiFi, WiFi Direct (WiFi-D), Bluetooth®, Zigbee etc. The wireless transceivers 610 and 612 may be communicatively coupled to a transceiver interface, e.g., by optical and/or electrical connection, which may be at least partially integrated with the wireless transceivers 610 and 612.

In some embodiments, UE 600 may include antenna 611, which may be internal or external. UE antenna 611 may be used to transmit and/or receive signals processed by wireless transceivers 610 and 612. In some embodiments, UE antenna 611 may be coupled to wireless transceivers 610 and 612. In some embodiments, measurements of signals received (transmitted) by UE 600 may be performed at the point of connection of the UE antenna 611 and wireless transceivers 610 and 612. For example, the measurement point of reference for received (transmitted) RF signal measurements may be an input (output) terminal of the receiver 610r (transmitter 610t) and an output (input) terminal of the UE antenna 611. In a UE 600 with multiple UE antennas 611 or antenna arrays, the antenna connector may be viewed as a virtual point representing the aggregate output (input) of multiple UE antennas. In some embodiments, UE 600 may measure received signals including signal strength and TOA measurements and the raw measurements may be processed by the one or more processors 602.

The one or more processors 602 may be implemented using a combination of hardware, firmware, and software. For example, the one or more processors 602 may be configured to perform the functions discussed herein by implementing one or more instructions or program code 608 on a non-transitory computer readable medium, such as medium 620 and/or memory 604. In some embodiments, the one or more processors 602 may represent one or more circuits configurable to perform at least a portion of a data signal computing procedure or process related to the operation of UE 600.

The medium 620 and/or memory 604 may store instructions or program code 608 that contain executable code or software instructions that when executed by the one or more processors 602 cause the one or more processors 602 to operate as a special purpose computer programmed to perform the techniques disclosed herein. As illustrated in UE 600, the medium 620 and/or memory 604 may include one or more components or modules that may be implemented by the one or more processors 602 to perform the methodologies described herein. While the components or modules are illustrated as software in medium 620 that is executable by the one or more processors 602, it should be understood that the components or modules may be stored in memory 604 or may be dedicated hardware either in the one or more processors 602 or off the processors.

A number of software modules and data tables may reside in the medium 620 and/or memory 604 and be utilized by the one or more processors 602 in order to manage both communications and the functionality described herein. It should be appreciated that the organization of the contents of the medium 620 and/or memory 604 as shown in UE 600 is merely exemplary, and as such the functionality of the modules and/or data structures may be combined, separated, and/or be structured in different ways depending upon the implementation of the UE 600.

The medium 620 and/or memory 604 may include an SRS configuration module 622 that when implemented by the one or more processors 602 configures the one or more processors 602 to receive, e.g., via the wireless transceiver 610, a configuration for sounding reference signal (SRS) periodic burst transmissions that includes a plurality of sets of SRS transmissions, each set of SRS transmissions including a repetition of SRS resources, as discussed herein. The configuration for the SRS periodic burst transmissions for example, may include a start time for the SRS periodic burst transmissions, a repetition configuration for the SRS resources, and a repetition configuration for the plurality of sets of SRS transmissions. As discussed in FIG. 4, the start time for the SRS periodic burst transmissions may be a starting slot or slot offset, the repetition configuration for the SRS resources may be an SRS resource period, and the repetition configuration for the plurality of sets of SRS transmissions may be a period for the sets of SRS transmissions.

The medium 620 and/or memory 604 may include an SRS transmission module 624 that when implemented by the one or more processors 602 configures the one or more processors 602 to transmit, via the wireless transceiver 610, SRS for positioning to one or more base stations based on the configuration for the SRS periodic burst transmissions.

The medium 620 and/or memory 604 may include an SRS activate/deactivate module 626 that when implemented by the one or more processors 602 configures the one or more processors 602 to receive, via the wireless transceiver 610, an activation message to activate the SRS periodic burst transmissions and to receive, via the wireless transceiver 610, a deactivation message to deactivate the SRS periodic burst transmissions. The activate message may be included with or separately from the configuration SRS periodic burst transmissions. In one implementation, the activate message, for example, may be a Radio Resource Control (RRC) configuration message and the deactivate message, for example, may be an RRC reconfiguration message. In one implementation, the activate message, for example, may be a first Medium Access Control-Control Element (MAC-CE) message and the deactivate message, for example, may be a second MAC-CE message.

The methodologies described herein may be implemented by various means depending upon the application. For example, these methodologies may be implemented in hardware, firmware, software, or any combination thereof. For a hardware implementation, the one or more processors 602 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 620 or memory 604 that is connected to and executed by the one or more processors 602. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 608 on a non-transitory computer readable medium, such as medium 620 and/or memory 604. Examples include computer readable media encoded with a data structure and computer readable media encoded with a computer program code 608. For example, the non-transitory computer readable medium including program code 608 stored thereon may include program code 608 to support UE positioning using periodic burst SRS resources in a manner consistent with disclosed embodiments. Non-transitory computer readable medium 620 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 608 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 620, instructions and/or data may be provided as signals on transmission media included in a communication apparatus. For example, a communication apparatus may include a wireless transceiver 610 having signals indicative of instructions and data. The instructions and data are configured to cause one or more processors to implement the functions outlined in the claims. That is, the communication apparatus includes transmission media with signals indicative of information to perform disclosed functions.

Memory 604 may represent any data storage mechanism. Memory 604 may include, for example, a primary memory and/or a secondary memory. Primary memory may include, for example, a random access memory, read only memory, etc. While illustrated in this example as being separate from one or more processors 602, it should be understood that all or part of a primary memory may be provided within or otherwise co-located/coupled with the one or more processors 602. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 620. As such, in certain example implementations, the methods and/or apparatuses presented herein may take the form in whole or part of a computer readable medium 620 that may include computer implementable program code 608 stored thereon, which if executed by one or more processors 602 may be operatively enabled to perform all or portions of the example operations as described herein. Computer readable medium 620 may be a part of memory 604.

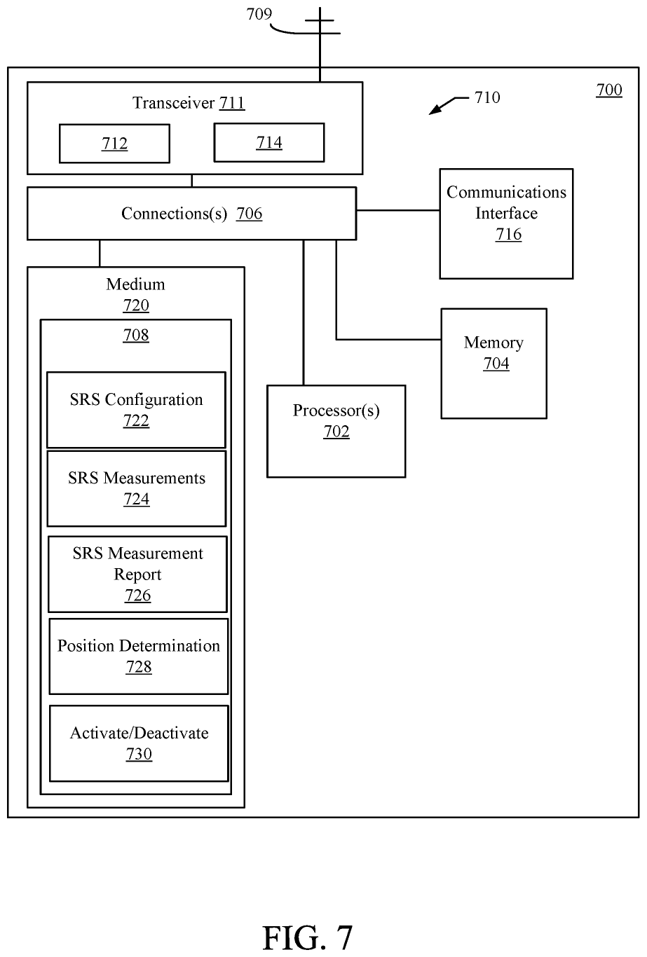

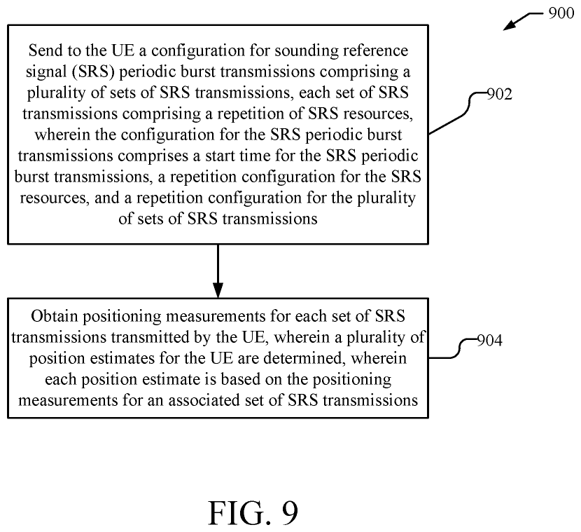

FIG. 7 shows a schematic block diagram illustrating certain exemplary features of a network entity 700 that is configured to support UE positioning using periodic burst SRS resources, as discussed herein. The network entity 700, for example, may be a base station, such as gNB 110 shown in FIGS. 1 and 5, or may be a location server, such as LMF 152 shown in FIGS. 1 and 5. The network entity 700, for example, may perform the signal flows shown in FIG. 5 and the process flow shown in FIG. 9 and algorithms disclosed herein.

The network entity 700 may, for example, include one or more processors 702, memory 704, and an external interface 710, which may include a wireless transceiver 711 for wirelessly communicating with UEs and/or a communications interface 716 for communicating with other network entities (if the network entity 700 is a base station, such as gNB 110, the external interface 710 may include both the wireless transceiver 711 and the communications interface 716, whereas if the network entity 700 is a location server, such as LMF 152, the external interface 710 may include the communications interface 716 and may or may not include the wireless transceiver 711). The one or more processors 702, memory 704, and external interface 710 may be operatively coupled with one or more connections 706 (e.g., buses, lines, fibers, links, etc.) to non-transitory computer readable medium 720 and memory 704. The wireless transceiver 711 may be a transceiver for communicating with the UE 102, e.g., if the network entity 700 is a base station, such as a serving gNB. The wireless transceiver 711 may include a transmitter 712 and receiver 714 coupled to one or more antennas 709 for transmitting (e.g., on one or more downlink channels) and/or receiving (e.g., on one or more uplink channels) wireless signals and transducing signals from the wireless signals to wired (e.g., electrical and/or optical) signals and from wired (e.g., electrical and/or optical) signals to the wireless signals. The communications interface 716 may be wireline or wireless network interface between network entities, such as to the AMF 154 through which the network entity may communicate with the location server (if the network entity 700 is a base station) or with a base station (if the network entity 700 is a location server). In certain example implementations, all or part of network entity 700 may take the form of a chipset, and/or the like.

The one or more processors 702 may be implemented using a combination of hardware, firmware, and software. For example, the one or more processors 702 may be configured to perform the functions discussed herein by implementing one or more instructions or program code 708 on a non-transitory computer readable medium, such as medium 720 and/or memory 704. In some embodiments, the one or more processors 702 may represent one or more circuits configurable to perform at least a portion of a data signal computing procedure or process related to the operation of network entity 700.

The medium 720 and/or memory 704 may store instructions or program code 708 that contain executable code or software instructions that when executed by the one or more processors 702 cause the one or more processors 702 to operate as a special purpose computer programmed to perform the techniques disclosed herein. As illustrated in network entity 700, the medium 720 and/or memory 704 may include one or more components or modules that may be implemented by the one or more processors 702 to perform the methodologies described herein. While the components or modules are illustrated as software in medium 720 that is executable by the one or more processors 702, it should be understood that the components or modules may be stored in memory 704 or may be dedicated hardware either in the one or more processors 702 or off the processors.

A number of software modules and data tables may reside in the medium 720 and/or memory 704 and be utilized by the one or more processors 702 in order to manage both communications and the functionality described herein. It should be appreciated that the organization of the contents of the medium 720 and/or memory 704 as shown in network entity 700 is merely exemplary, and as such the functionality of the modules and/or data structures may be combined, separated, and/or be structured in different ways depending upon the implementation of the network entity 700.

The medium 720 and/or memory 704 may include an SRS configuration module 722 that when implemented by the one or more processors 702 configures the one or more processors 702 to send, e.g., via the external interface 710, to the UE a configuration for sounding reference signal (SRS) periodic burst transmissions that includes a plurality of sets of SRS transmissions, each set of SRS transmissions comprising a repetition of SRS resources, as discussed herein. The configuration for the SRS periodic burst transmissions for example, may include a start time for the SRS periodic burst transmissions, a repetition configuration for the SRS resources, and a repetition configuration for the plurality of sets of SRS transmissions. As discussed in FIG. 4, the start time for the SRS periodic burst transmissions may be a starting slot or slot offset, the repetition configuration for the SRS resources may be an SRS resource period, and the repetition configuration for the plurality of sets of SRS transmissions may be a period for the sets of SRS transmissions.

The medium 720 and/or memory 704 may include an SRS measurement module 724, that when implemented by the one or more processors 702 configures the one or more processors 702 to obtain positioning measurements for each set of SRS transmissions transmitted by the UE, wherein a plurality of position estimates for the UE are determined, wherein each position estimate is based on the positioning measurements for an associated set of SRS transmissions. For example, if the network entity 700 is a base station, the one or more processors 702 may be configured to receive the SRS resources from the UE, via the wireless transceiver 711 and generate the positioning measurements for each set of SRS transmissions transmitted by the UE. If the network entity 700 is a location server, the one or more processors 702 may be configured to receive, via the communications interface 716, the positioning measurements for each set of SRS transmissions from one or more base stations.

The medium 720 and/or memory 704 may include an SRS measurement report module 726, that when implemented by the one or more processors 702 configures the one or more processors 702, if the network entity 700 is a base station, to send, via the communications interface 716, the positioning measurements to a location server for determining the plurality of position estimates for the UE, and if the network entity 700 is a location server, to receive, via the communications interface 716, the positioning measurements for each set of SRS transmissions from one or more base stations.

The medium 720 and/or memory 704 may include a position determination module 728 that when implemented by the one or more processors 702 configures the one or more processors 702 to determine determining the positioning measurements the plurality of position estimates for the UE based on received positioning measurements.

The medium 720 and/or memory 704 may include an activate/deactivate module 730 that when implemented by the one or more processors 702 configures the one or more processors 702 to send, via the external interface 710, an activation message to activate the SRS periodic burst transmissions and to send, via the external interface 710, a deactivation message to deactivate the SRS periodic burst transmissions. The activate message may be included with or separately from the configuration SRS periodic burst transmissions. In one implementation, the activate message, for example, may be a Radio Resource Control (RRC) configuration message and the deactivate message, for example, may be an RRC reconfiguration message. In one implementation, the activate message, for example, may be a first Medium Access Control-Control Element (MAC-CE) message and the deactivate message, for example, may be a second MAC-CE message.

The methodologies described herein may be implemented by various means depending upon the application. For example, these methodologies may be implemented in hardware, firmware, software, or any combination thereof. For a hardware implementation, the one or more processors 702 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 720 or memory 704 that is connected to and executed by the one or more processors 702. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 708 on a non-transitory computer readable medium, such as medium 720 and/or memory 704. Examples include computer readable media encoded with a data structure and computer readable media encoded with a computer program code 708. For example, the non-transitory computer readable medium including program code 708 stored thereon may include program code 708 to support UE positioning using periodic burst SRS resources in a manner consistent with disclosed embodiments. Non-transitory computer readable medium 720 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 708 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 720, instructions and/or data may be provided as signals on transmission media included in a communication apparatus. For example, a communication apparatus may include an external interface 710 having signals indicative of instructions and data. The instructions and data are configured to cause one or more processors to implement the functions outlined in the claims. That is, the communication apparatus includes transmission media with signals indicative of information to perform disclosed functions.

Memory 704 may represent any data storage mechanism. Memory 704 may include, for example, a primary memory and/or a secondary memory. Primary memory may include, for example, a random access memory, read only memory, etc. While illustrated in this example as being separate from one or more processors 702, it should be understood that all or part of a primary memory may be provided within or otherwise co-located/coupled with the one or more processors 702. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 720. As such, in certain example implementations, the methods and/or apparatuses presented herein may take the form in whole or part of a computer readable medium 720 that may include computer implementable program code 708 stored thereon, which if executed by one or more processors 702 may be operatively enabled to perform all or portions of the example operations as described herein. Computer readable medium 720 may be a part of memory 704.

FIG. 8 shows a flowchart for an exemplary method 800 for positioning a user equipment (UE) performed by the UE, such as UE 102 shown in FIG. 1 or UE 600 shown in FIG. 6, in a manner consistent with disclosed implementations.

At block 802, the UE receives a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions, e.g., as discussed at stages 4 or 7 of FIG. 5. For example, the start time for the SRS periodic burst transmissions may be a starting slot or slot offset, e.g., as discussed at FIG. 4 and stages 4 or 7 of FIG. 5. For example, the repetition configuration for the SRS resources may be an SRS resource period as discussed at FIG. 4 and stages 4 or 7 of FIG. 5. For example, the repetition configuration for the plurality of sets of SRS transmissions may be a period for the plurality of sets of SRS transmissions as discussed at FIG. 4 and stages 4 or 7 of FIG. 5. A means for receiving a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions may include, e.g., the wireless transceiver 610 and one or more processors 602 with dedicated hardware or implementing executable code or software instructions in memory 604 and/or medium 620 in UE 600, such as the SRS configuration module 622, shown in FIG. 6.

At block 804, the UE transmits the SRS periodic burst transmissions to one or more base stations for positioning, e.g., as discussed at stage 9 and blocks 510, 520, and 530, and FIG. 4. A means for transmitting the SRS periodic burst transmissions to one or more base stations for positioning may include, e.g., the wireless transceiver 610 and one or more processors 602 with dedicated hardware or implementing executable code or software instructions in memory 604 and/or medium 620 in UE 600, such as the SRS transmission module 624, shown in FIG. 6.

In one implementation, the configuration for the SRS periodic burst transmissions may be received in a Radio Resource Control (RRC) configuration message that activates the SRS periodic burst transmissions, e.g., as discussed at stages 4 or 7 of FIG. 5, and the UE may further receive a RRC reconfiguration message that deactivates the SRS periodic burst transmissions, e.g., as discussed at stage 14 of FIG. 5. A means for receiving a RRC reconfiguration message that deactivates the SRS periodic burst transmissions may include, e.g., the wireless transceiver 610 and one or more processors 602 with dedicated hardware or implementing executable code or software instructions in memory 604 and/or medium 620 in UE 600, such as the SRS activate/deactivate module 626, shown in FIG. 6.

In one implementation, the configuration for the SRS periodic burst transmissions may be received in a first Medium Access Control-Control Element (MAC-CE) message that activates the SRS periodic burst transmissions, e.g., as discussed at stages 4 or 7 of FIG. 5, and the UE may receive a second MAC-CE message that deactivates the SRS periodic burst transmissions, e.g., as discussed at stage 14 of FIG. 5. A means for receiving a second MAC-CE message that deactivates the SRS periodic burst transmissions may include, e.g., the wireless transceiver 610 and one or more processors 602 with dedicated hardware or implementing executable code or software instructions in memory 604 and/or medium 620 in UE 600, such as the SRS activate/deactivate module 626, shown in FIG. 6.

FIG. 9 shows a flowchart for an exemplary method 900 for positioning a user equipment (UE) performed by a network entity, in a manner consistent with disclosed implementations. The network entity, for example, may be network entity 700 shown in FIG. 7, which may be a base station, such as a gNB 110 shown in FIG. 1 or a location server, such as LMF 152 shown in FIG. 1.

At block 902, the network entity may send to the UE a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions, e.g., as discussed at stages 4 or 7 of FIG. 5. For example, the start time for the SRS periodic burst transmissions may be a starting slot or slot offset, e.g., as discussed at stages 4 or 7 of FIG. 5. For example, the repetition configuration for the SRS resources may be an SRS resource period, e.g., as discussed at stages 4 or 7 of FIG. 5. For example, the repetition configuration for the plurality of sets of SRS transmissions may be a period for the plurality of sets of SRS transmissions, e.g., as discussed at stages 4 or 7 of FIG. 5. A means for sending to the UE a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions may include, e.g., the external interface 710 and one or more processors 702 with dedicated hardware or implementing executable code or software instructions in memory 704 and/or medium 720 in the network entity 700, such as the SRS configuration module 722, shown in FIG. 7.

At block 904, the network entity may obtain positioning measurements for each set of SRS transmissions transmitted by the UE, wherein a plurality of position estimates for the UE are determined, wherein each position estimate is based on the positioning measurements for an associated set of SRS transmissions, e.g., as discussed at stages 10 or 11 of FIG. 5. A means for obtaining positioning measurements for each set of SRS transmissions transmitted by the UE, wherein a plurality of position estimates for the UE are determined, wherein each position estimate is based on the positioning measurements for an associated set of SRS transmissions may include, e.g., the external interface 710 and one or more processors 702 with dedicated hardware or implementing executable code or software instructions in memory 704 and/or medium 720 in the network entity 700, such as the SRS measurement module 724, shown in FIG. 7.

In one implementation, the network entity may be a base station, and may obtain the positioning measurements for each set of SRS transmissions by generating the positioning measurements for each set of SRS transmissions transmitted by the UE, e.g., as discussed at stage 10 of FIG. 5. The network entity may further send the positioning measurements to a location server for determining the plurality of position estimates for the UE, e.g., as discussed at stage 11 of FIG. 5. A means for generating the positioning measurements for each set of SRS transmissions transmitted by the UE may include, e.g., the external interface 710 and one or more processors 702 with dedicated hardware or implementing executable code or software instructions in memory 704 and/or medium 720 in the network entity 700, such as the SRS measurement module 724, shown in FIG. 7. A means for sending the positioning measurements to a location server for determining the plurality of position estimates for the UE may include, e.g., the communications interface 716 and one or more processors 702 with dedicated hardware or implementing executable code or software instructions in memory 704 and/or medium 720 in the network entity 700, such as the SRS measurement report module 726, shown in FIG. 7.

In one implementation, the network entity may be a location server, and may obtain the positioning measurements for each set of SRS transmissions by receiving the positioning measurements for each set of SRS transmissions from one or more base stations, e.g., as discussed at stage 11 of FIG. 5. The network entity may further determine the plurality of position estimates for the UE based on the received positioning measurements, e.g., as discussed at stage 12 of FIG. 5. A means for receiving the positioning measurements for each set of SRS transmissions from one or more base stations may include, e.g., the communications interface 716 and one or more processors 702 with dedicated hardware or implementing executable code or software instructions in memory 704 and/or medium 720 in the network entity 700, such as the SRS measurement report module 726, shown in FIG. 7. A means for determining the plurality of position estimates for the UE based on the received positioning measurements may include, e.g., the one or more processors 702 with dedicated hardware or implementing executable code or software instructions in memory 704 and/or medium 720 in the network entity 700, such as the position determination module 728, shown in FIG. 7.

In one implementation, the configuration for the SRS periodic burst transmissions may be sent to the UE in a Radio Resource Control (RRC) configuration message that activates the SRS periodic burst transmissions, e.g., as discussed at stages 4 or 7 of FIG. 5 and the network entity may further send a reconfiguration message to the UE in a RRC reconfiguration message that deactivates the SRS periodic burst transmissions, e.g., as discussed at stage 14 of FIG. 5. A means for sending a reconfiguration message to the UE in a RRC reconfiguration message that deactivates the SRS periodic burst transmissions may include, e.g., the external interface 710 and one or more processors 702 with dedicated hardware or implementing executable code or software instructions in memory 704 and/or medium 720 in the network entity 700, such as the activate/deactivate module 730, shown in FIG. 7.

In one implementation, the configuration for the SRS periodic burst transmissions is sent to the UE in a first Medium Access Control-Control Element (MAC-CE) message that activates the SRS periodic burst transmissions, e.g., as discussed at stages 4 or 7 of FIG. 5 and the network entity may further send a reconfiguration message to the UE in a second MAC-CE message that deactivates the SRS periodic burst transmissions, e.g., as discussed at stage 14 of FIG. 5. A means for sending a reconfiguration message to the UE in a second MAC-CE message that deactivates the SRS periodic burst transmissions may include, e.g., the external interface 710 and one or more processors 702 with dedicated hardware or implementing executable code or software instructions in memory 704 and/or medium 720 in the network entity 700, such as the activate/deactivate module 730, shown in FIG. 7.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures, or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

In view of this description embodiments may include different combinations of features. Implementation examples are described in the following numbered clauses:

Clause 1. A method performed by a user equipment (UE) for positioning of the UE, the method comprising: receiving a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and transmitting the SRS periodic burst transmissions to one or more base stations for positioning.

Clause 2. The method of clause 1, wherein the start time for the SRS periodic burst transmissions comprises a starting slot or slot offset.

Clause 3. The method of any of clause 1-2, wherein the repetition configuration for the SRS resources comprises an SRS resource period.

Clause 4. The method of any of clauses 1-3, wherein the repetition configuration for the plurality of sets of SRS transmissions comprises a period for the plurality of sets of SRS transmissions.

Clause 5. The method of any of clauses 1-4, wherein the configuration for the SRS periodic burst transmissions is received in a Radio Resource Control (RRC) configuration message that activates the SRS periodic burst transmissions, the method further comprising receiving a RRC reconfiguration message that deactivates the SRS periodic burst transmissions.

Clause 6. The method of any of clauses 1-4, wherein the configuration for the SRS periodic burst transmissions is received in a first Medium Access Control-Control Element (MAC-CE) message that activates the SRS periodic burst transmissions, the method further comprising receiving a second MAC-CE message that deactivates the SRS periodic burst transmissions.

Clause 7. A user equipment (UE) configured for positioning of the UE, comprising: a wireless transceiver configured to wirelessly communicate with base stations in a wireless network; at least one memory; and at least one processor coupled to the wireless transceiver and the at least one memory and configured to: receive, via the wireless transceiver, a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and transmit, via the wireless transceiver, the SRS periodic burst transmissions to one or more base stations for positioning.

Clause 8. The UE of clause 7, wherein the start time for the SRS periodic burst transmissions comprises a starting slot or slot offset.

Clause 9. The UE of any of clauses 7-8, wherein the repetition configuration for the SRS resources comprises an SRS resource period.

Clause 10. The UE of any of clauses 7-9, wherein the repetition configuration for the plurality of sets of SRS transmissions comprises a period for the plurality of sets of SRS transmissions.

Clause 11. The UE of any of clauses 7-10, wherein the configuration for the SRS periodic burst transmissions is received in a Radio Resource Control (RRC) configuration message that activates the SRS periodic burst transmissions, the at least one processor is further configured to receive, via the wireless transceiver, a RRC reconfiguration message that deactivates the SRS periodic burst transmissions.

Clause 12. The UE of any of clauses 7-10, wherein the configuration for the SRS periodic burst transmissions is received in a first Medium Access Control-Control Element (MAC-CE) message that activates the SRS periodic burst transmissions, the at least one processor is further configured to receive, via the wireless transceiver, a second MAC-CE message that deactivates the SRS periodic burst transmissions.

Clause 13. A user equipment (UE) configured for positioning of the UE, comprising: means for receiving a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and means for transmitting the SRS periodic burst transmissions to one or more base stations for positioning.

Clause 14. The UE of clause 13, wherein the start time for the SRS periodic burst transmissions comprises a starting slot or slot offset.

Clause 15. The UE of any of clauses 13-14, wherein the repetition configuration for the SRS resources comprises an SRS resource period.

Clause 16. The UE of any of clauses 13-15, wherein the repetition configuration for the plurality of sets of SRS transmissions comprises a period for the plurality of sets of SRS transmissions.

Clause 17. The UE of any of clauses 13-16, wherein the configuration for the SRS periodic burst transmissions is received in a Radio Resource Control (RRC) configuration message that activates the SRS periodic burst transmissions, further comprising means for receiving a RRC reconfiguration message that deactivates the SRS periodic burst transmissions.

Clause 18. The UE of any of clauses 13-16, wherein the configuration for the SRS periodic burst transmissions is received in a first Medium Access Control-Control Element (MAC-CE) message that activates the SRS periodic burst transmissions, further comprising means for receiving a second MAC-CE message that deactivates the SRS periodic burst transmissions.

Clause 19. A non-transitory computer-readable storage medium including program code stored thereon, the program code is operable to configure at least one processor in a user equipment (UE) for positioning of the UE, the program code comprising instructions to: receive a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and transmit the SRS periodic burst transmissions to one or more base stations for positioning.

Clause 20. The non-transitory computer-readable storage medium of clause 19, wherein the start time for the SRS periodic burst transmissions comprises a starting slot or slot offset.

Clause 21. The non-transitory computer-readable storage medium of any of clauses 19-20, wherein the repetition configuration for the SRS resources comprises an SRS resource period.

Clause 22. The non-transitory computer-readable storage medium of any of clauses 19-21, wherein the repetition configuration for the plurality of sets of SRS transmissions comprises a period for the plurality of sets of SRS transmissions.

Clause 23. The non-transitory computer-readable storage medium of any of clauses 19-22, wherein the configuration for the SRS periodic burst transmissions is received in a Radio Resource Control (RRC) configuration message that activates the SRS periodic burst transmissions, the program code further comprises instructions to receive a RRC reconfiguration message that deactivates the SRS periodic burst transmissions.

Clause 24. The non-transitory computer-readable storage medium of any of clauses 19-22, wherein the configuration for the SRS periodic burst transmissions is received in a first Medium Access Control-Control Element (MAC-CE) message that activates the SRS periodic burst transmissions, the program code further comprises instructions to receive a second MAC-CE message that deactivates the SRS periodic burst transmissions.

Clause 25. A method performed by a network entity for positioning of a user equipment (UE), the method comprising: sending to the UE a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and obtaining positioning measurements for each set of SRS transmissions transmitted by the UE, wherein a plurality of position estimates for the UE are determined, wherein each position estimate is based on the positioning measurements for an associated set of SRS transmissions.

Clause 26. The method of clause 25, wherein the network entity is a base station and obtaining the positioning measurements for each set of SRS transmissions comprises generating the positioning measurements for each set of SRS transmissions transmitted by the UE, the method further comprising sending the positioning measurements to a location server for determining the plurality of position estimates for the UE.

Clause 27. The method of clause 25, wherein the network entity is a location server and obtaining the positioning measurements for each set of SRS transmissions comprises receiving the positioning measurements for each set of SRS transmissions from one or more base stations, the method further comprising determining the plurality of position estimates for the UE based on the received positioning measurements.

Clause 28. The method of any of clauses 25-27, wherein the start time for the SRS periodic burst transmissions comprises a starting slot or slot offset.

Clause 29. The method of any of clauses 25-28, wherein the repetition configuration for the SRS resources comprises an SRS resource period.

Clause 30. The method of any of clauses 25-29, wherein the repetition configuration for the plurality of sets of SRS transmissions comprises a period for the plurality of sets of SRS transmissions.

Clause 31. The method of any of clauses 25-30, wherein the configuration for the SRS periodic burst transmissions is sent to the UE in a Radio Resource Control (RRC) configuration message that activates the SRS periodic burst transmissions, the method further comprising sending a reconfiguration message to the UE in a RRC reconfiguration message that deactivates the SRS periodic burst transmissions.

Clause 32. The method of any of clauses 25-31, wherein the configuration for the SRS periodic burst transmissions is sent to the UE in a first Medium Access Control-Control Element (MAC-CE) message that activates the SRS periodic burst transmissions, the method further comprising sending a reconfiguration message to the UE in a second MAC-CE message that deactivates the SRS periodic burst transmissions.

Clause 33. A network entity configured for positioning of a user equipment (UE), comprising: an external interface configured to wirelessly communicate with entities in a wireless network; at least one memory; and at least one processor coupled to the external interface and the at least one memory and configured to: send, via the external interface, to the UE a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and obtain, via the external interface, positioning measurements for each set of SRS transmissions transmitted by the UE, wherein a plurality of position estimates for the UE are determined, wherein each position estimate is based on the positioning measurements for an associated set of SRS transmissions.

Clause 34. The network entity of clause 33, wherein the network entity is a base station, the at least one processor is configured to obtain the positioning measurements for each set of SRS transmissions by being configured to generate the positioning measurements for each set of SRS transmissions transmitted by the UE, the at least one processor is further configured to send, via the external interface, the positioning measurements to a location server for determining the plurality of position estimates for the UE.

Clause 35. The network entity of clause 33, wherein the network entity is a location server, the at least one processor is configured to obtain the positioning measurements for each set of SRS transmissions by being configured to receive, via the external interface, the positioning measurements for each set of SRS transmissions from one or more base stations, the at least one processor is further configured to determine the plurality of position estimates for the UE based on the received positioning measurements.

Clause 36. The network entity of any of clauses 33-35, wherein the start time for the SRS periodic burst transmissions comprises a starting slot or slot offset.

Clause 37. The network entity of any of clauses 33-36, wherein the repetition configuration for the SRS resources comprises an SRS resource period.

Clause 38. The network entity of any of clauses 33-37, wherein the repetition configuration for the plurality of sets of SRS transmissions comprises a period for the plurality of sets of SRS transmissions.

Clause 39. The network entity of any of clauses 33-38, wherein the configuration for the SRS periodic burst transmissions is sent to the UE in a Radio Resource Control (RRC) configuration message that activates the SRS periodic burst transmissions, the at least one processor is further configured to send, via the external interface, a reconfiguration message to the UE in a RRC reconfiguration message that deactivates the SRS periodic burst transmissions.

Clause 40. The network entity of any of clauses 33-38, wherein the configuration for the SRS periodic burst transmissions is sent to the UE in a first Medium Access Control-Control Element (MAC-CE) message that activates the SRS periodic burst transmissions, the at least one processor is further configured to send, via the external interface, a reconfiguration message to the UE in a second MAC-CE message that deactivates the SRS periodic burst transmissions.

Clause 41. A network entity configured for positioning of a user equipment (UE), comprising: means for sending to the UE a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and means for obtaining positioning measurements for each set of SRS transmissions transmitted by the UE, wherein a plurality of position estimates for the UE are determined, wherein each position estimate is based on the positioning measurements for an associated set of SRS transmissions.

Clause 42. The network entity of clause 41, wherein the network entity is a base station and obtaining the positioning measurements for each set of SRS transmissions comprises generating the positioning measurements for each set of SRS transmissions transmitted by the UE, further comprising means for sending the positioning measurements to a location server for determining the plurality of position estimates for the UE.

Clause 43. The network entity of clause 41, wherein the network entity is a location server and obtaining the positioning measurements for each set of SRS transmissions comprises receiving the positioning measurements for each set of SRS transmissions from one or more base stations, further comprising means for determining the plurality of position estimates for the UE based on the received positioning measurements.

Clause 44. The network entity of any of clauses 41-43, wherein the start time for the SRS periodic burst transmissions comprises a starting slot or slot offset.

Clause 45. The network entity of any of clauses 41-44, wherein the repetition configuration for the SRS resources comprises an SRS resource period.

Clause 46. The network entity of any of clauses 41-45, wherein the repetition configuration for the plurality of sets of SRS transmissions comprises a period for the plurality of sets of SRS transmissions.

Clause 47. The network entity of any of clauses 41-46, wherein the configuration for the SRS periodic burst transmissions is sent to the UE in a Radio Resource Control (RRC) configuration message that activates the SRS periodic burst transmissions, further comprising means for sending a reconfiguration message to the UE in a RRC reconfiguration message that deactivates the SRS periodic burst transmissions.

Clause 48. The network entity of any of clauses 41-46, wherein the configuration for the SRS periodic burst transmissions is sent to the UE in a first Medium Access Control-Control Element (MAC-CE) message that activates the SRS periodic burst transmissions, further comprising means for sending a reconfiguration message to the UE in a second MAC-CE message that deactivates the SRS periodic burst transmissions.

Clause 49. A non-transitory computer-readable storage medium including program code stored thereon, the program code is operable to configure at least one processor in a network entity for positioning of a user equipment (UE), the program code comprising instructions to: send to the UE a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and obtain positioning measurements for each set of SRS transmissions transmitted by the UE, wherein a plurality of position estimates for the UE are determined, wherein each position estimate is based on the positioning measurements for an associated set of SRS transmissions.

Clause 50. The non-transitory computer-readable storage medium of clause 49, wherein the network entity is a base station, the at least one processor is configured to obtain the positioning measurements for each set of SRS transmissions by being configured to generate the positioning measurements for each set of SRS transmissions transmitted by the UE, the program code further comprising instructions to send the positioning measurements to a location server for determining the plurality of position estimates for the UE.

Clause 51. The non-transitory computer-readable storage medium of clause 49, wherein the network entity is a location server, the program code further comprising instructions to obtain the positioning measurements for each set of SRS transmissions by being configured to receive, via the external interface, the positioning measurements for each set of SRS transmissions from one or more base stations, the program code further comprising instructions to determine the plurality of position estimates for the UE based on the received positioning measurements.

Clause 52. The non-transitory computer-readable storage medium of any of clauses 49-51, wherein the start time for the SRS periodic burst transmissions comprises a starting slot or slot offset.

Clause 53. The non-transitory computer-readable storage medium of any of clauses 49-52, wherein the repetition configuration for the SRS resources comprises an SRS resource period.

Clause 54. The non-transitory computer-readable storage medium of any of clauses 49-53, wherein the repetition configuration for the plurality of sets of SRS transmissions comprises a period for the plurality of sets of SRS transmissions.

Clause 55. The non-transitory computer-readable storage medium of any of clauses 49-54, wherein the configuration for the SRS periodic burst transmissions is sent to the UE in a Radio Resource Control (RRC) configuration message that activates the SRS periodic burst transmissions, the program code further comprising instructions to send a reconfiguration message to the UE in a RRC reconfiguration message that deactivates the SRS periodic burst transmissions.

Clause 56. The non-transitory computer-readable storage medium of any of clauses 49-55, wherein the configuration for the SRS periodic burst transmissions is sent to the UE in a first Medium Access Control-Control Element (MAC-CE) message that activates the SRS periodic burst transmissions, the program code further comprising instructions to send a reconfiguration message to the UE in a second MAC-CE message that deactivates the SRS periodic burst transmissions.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method performed by a user equipment (UE) for positioning of the UE, the method comprising:
receiving a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and
transmitting the SRS periodic burst transmissions to one or more base stations for positioning.

2. The method of claim 1, wherein the start time for the SRS periodic burst transmissions comprises a starting slot or slot offset.

3. The method of claim 1, wherein the repetition configuration for the SRS resources comprises an SRS resource period.

4. The method of claim 1, wherein the repetition configuration for the plurality of sets of SRS transmissions comprises a period for the plurality of sets of SRS transmissions.

5. The method of claim 1, wherein the configuration for the SRS periodic burst transmissions is received in a Radio Resource Control (RRC) configuration message that activates the SRS periodic burst transmissions, the method further comprising receiving a RRC reconfiguration message that deactivates the SRS periodic burst transmissions.

6. The method of claim 1, wherein the configuration for the SRS periodic burst transmissions is received in a first Medium Access Control-Control Element (MAC-CE) message that activates the SRS periodic burst transmissions, the method further comprising receiving a second MAC-CE message that deactivates the SRS periodic burst transmissions.

7. A user equipment (UE) configured for positioning of the UE, comprising:
a wireless transceiver configured to wirelessly communicate with base stations in a wireless network;
at least one memory; and
at least one processor coupled to the wireless transceiver and the at least one memory and configured to:
receive, via the wireless transceiver, a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and
transmit, via the wireless transceiver, the SRS periodic burst transmissions to one or more base stations for positioning.

8. The UE of claim 7, wherein the start time for the SRS periodic burst transmissions comprises a starting slot or slot offset.

9. The UE of claim 7, wherein the repetition configuration for the SRS resources comprises an SRS resource period.

10. The UE of claim 7, wherein the repetition configuration for the plurality of sets of SRS transmissions comprises a period for the plurality of sets of SRS transmissions.

11. The UE of claim 7, wherein the configuration for the SRS periodic burst transmissions is received in a Radio Resource Control (RRC) configuration message that activates the SRS periodic burst transmissions, the at least one processor is further configured to receive, via the wireless transceiver, a RRC reconfiguration message that deactivates the SRS periodic burst transmissions.

12. The UE of claim 7, wherein the configuration for the SRS periodic burst transmissions is received in a first Medium Access Control-Control Element (MAC-CE) message that activates the SRS periodic burst transmissions, the at least one processor is further configured to receive, via the wireless transceiver, a second MAC-CE message that deactivates the SRS periodic burst transmissions.

13. A method performed by a network entity for positioning of a user equipment (UE), the method comprising:
sending to the UE a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and
obtaining positioning measurements for each set of SRS transmissions transmitted by the UE, wherein a plurality of position estimates for the UE are determined, wherein each position estimate is based on the positioning measurements for an associated set of SRS transmissions.

14. The method of claim 13, wherein the network entity is a base station and obtaining the positioning measurements for each set of SRS transmissions comprises generating the positioning measurements for each set of SRS transmissions transmitted by the UE, the method further comprising sending the positioning measurements to a location server for determining the plurality of position estimates for the UE.

15. The method of claim 13, wherein the network entity is a location server and obtaining the positioning measurements for each set of SRS transmissions comprises receiving the positioning measurements for each set of SRS transmissions from one or more base stations, the method further comprising determining the plurality of position estimates for the UE based on the received positioning measurements.

16. The method of claim 13, wherein the start time for the SRS periodic burst transmissions comprises a starting slot or slot offset.

17. The method of claim 13, wherein the repetition configuration for the SRS resources comprises an SRS resource period.

18. The method of claim 13, wherein the repetition configuration for the plurality of sets of SRS transmissions comprises a period for the plurality of sets of SRS transmissions.

19. The method of claim 13, wherein the configuration for the SRS periodic burst transmissions is sent to the UE in a Radio Resource Control (RRC) configuration message that activates the SRS periodic burst transmissions, the method further comprising sending a reconfiguration message to the UE in a RRC reconfiguration message that deactivates the SRS periodic burst transmissions.

20. The method of claim 13, wherein the configuration for the SRS periodic burst transmissions is sent to the UE in a first Medium Access Control-Control Element (MAC-CE) message that activates the SRS periodic burst transmissions, the method further comprising sending a reconfiguration message to the UE in a second MAC-CE message that deactivates the SRS periodic burst transmissions.

21. A network entity configured for positioning of a user equipment (UE), comprising:
an external interface configured to wirelessly communicate with entities in a wireless network;
at least one memory; and
at least one processor coupled to the external interface and the at least one memory and configured to:
send, via the external interface, to the UE a configuration for sounding reference signal (SRS) periodic burst transmissions comprising a plurality of sets of SRS transmissions, each set of SRS transmissions comprising a repetition of SRS resources, wherein the configuration for the SRS periodic burst transmissions comprises a start time for the SRS periodic burst transmissions, a repetition configuration for the SRS resources, and a repetition configuration for the plurality of sets of SRS transmissions; and
obtain, via the external interface, positioning measurements for each set of SRS transmissions transmitted by the UE, wherein a plurality of position estimates for the UE are determined, wherein each position estimate is based on the positioning measurements for an associated set of SRS transmissions.

22. The network entity of claim 21, wherein the network entity is a base station, the at least one processor is configured to obtain the positioning measurements for each set of SRS transmissions by being configured to generate the positioning measurements for each set of SRS transmissions transmitted by the UE, the at least one processor is further configured to send, via the external interface, the positioning measurements to a location server for determining the plurality of position estimates for the UE.

23. The network entity of claim 21, wherein the network entity is a location server, the at least one processor is configured to obtain the positioning measurements for each set of SRS transmissions by being configured to receive, via the external interface, the positioning measurements for each set of SRS transmissions from one or more base stations, the at least one processor is further configured to determine the plurality of position estimates for the UE based on the received positioning measurements.

24. The network entity of claim 21, wherein the start time for the SRS periodic burst transmissions comprises a starting slot or slot offset.

25. The network entity of claim 21, wherein the repetition configuration for the SRS resources comprises an SRS resource period.

26. The network entity of claim 21, wherein the repetition configuration for the plurality of sets of SRS transmissions comprises a period for the plurality of sets of SRS transmissions.

27. The network entity of claim 21, wherein the configuration for the SRS periodic burst transmissions is sent to the UE in a Radio Resource Control (RRC) configuration message that activates the SRS periodic burst transmissions, the at least one processor is further configured to send, via the external interface, a reconfiguration message to the UE in a RRC reconfiguration message that deactivates the SRS periodic burst transmissions.

28. The network entity of claim 21, wherein the configuration for the SRS periodic burst transmissions is sent to the UE in a first Medium Access Control-Control Element (MAC-CE) message that activates the SRS periodic burst transmissions, the at least one processor is further configured to send, via the external interface, a reconfiguration message to the UE in a second MAC-CE message that deactivates the SRS periodic burst transmissions.
